(19) United States
(12) Patent Application Publication
(10) Pub. No.: US 2025/0356216 A1
(43) Pub. Date: Nov. 20, 2025

(54) WORKLOAD BALANCE WITH PROMPT AND TOKEN ROUTING FOR EXPERT MODELS

(71) Applicant: Bytedance Technology Ltd., Grand Cayman (KY)

(72) Inventors: Jinxin TAO, Los Angeles, CA (US); Yichen WANG, Los Angeles, CA (US); Xiaoning DING, Los Angeles, CA (US)

(21) Appl. No.: 19/291,230

(22) Filed: Aug. 5, 2025

(51) Int. Cl. G06N 3/10; G06N 3/045

(52) U.S. Cl. CPC G06N 3/105; G06N 3/045

(57) ABSTRACT

Systems and methods are provided for determining expert placement layouts and/or prompt and toke routing for a mixture of experts (MoE) model. In some instances, an expert workload distribution with respect to a plurality of experts is determined based on a gating neural network. In some instances, an expert placement layout with respect to a plurality of computing units is determined based on the determined expert workload distribution. In some instances, a two-level routing strategy is provided to first adaptively route an incoming prompt to a suitable computing device, then perform a token routing within that computing device to ensure workload balance between different computing units of that computing device.

### TECHNICAL FIELD

Certain embodiments of the present disclosure generally relate to machine learning models. More specifically, the disclosure relates to workload balancing during the inference process for expert models (e.g., a mixture of experts (MoE) model).

### BACKGROUND

A mixture of experts (MoE) is, in some examples, a conditional computation architecture that enables efficient scaling of neural networks by activating only a subset of model parameters per input. Instead of activating all experts for an input, in certain examples, a subset of the experts is used (e.g., typically a few experts per input), where each expert can be a small feedforward network. In some examples, a gating network decides which experts to activate for a given token. In some examples, a mixture of experts (MoE) is a machine learning model architecture where a model includes multiple specialized subnetworks, also referred to as experts, each trained to handle different aspects of a problem. In some examples, a gating network routes inputs to one or more experts.

### SUMMARY

Certain embodiments of the present disclosure generally relate to machine learning models. More specifically, the disclosure relates to workload balancing during the inference process for expert models (e.g., a mixture of experts (MoE) model).

As recited in examples, Example 1 is a method for determining expert placement layouts for a mixture of experts (MoE) model. The method includes receiving a plurality of tokens corresponding to an input prompt; receiving, by one or more processors, routing information of the plurality of tokens corresponding to at least a subset of a plurality of experts in one MoE layer of a plurality of MoE layers in the MoE model, the routing information including a subset of tokens per expert in the subset of the plurality of experts; determining, by the one or more processors, a respective expert workload for each expert in the at least the subset of the plurality of experts based on the routing information; determining, by the one or more processors, an expert workload distribution with respect to the plurality of experts based on the respective expert workload for each expert in the at least the subset of the plurality of experts; and determining, by the one or more processors, an expert placement layout with respect to a plurality of computing units based on the determined expert workload distribution for the one MoE layer of the plurality of MoE layers.

As recited in examples, Example 2 is a system for determining expert placement layouts for a mixture of experts (MoE) model. The system includes at least one processor, and memory storing instructions that, when executed by the at least one processor, cause the system to perform a set of operations. The set of operations includes receiving a plurality of tokens corresponding to an input prompt; receiving routing information of the plurality of tokens corresponding to at least a subset of a plurality of experts in one MoE layer of a plurality of MoE layers in the MoE model, the routing information including a subset of tokens per expert in the subset of the plurality of experts; determining a respective expert workload for each expert in the at least the subset of the plurality of experts based on the routing information; determining an expert workload distribution with respect to the plurality of experts based on the respective expert workload for each expert in the at least the subset of the plurality of experts; and determining an expert placement layout with respect to a plurality of computing units based on the determined expert workload distribution for the plurality of MoE layers.

As recited in examples, Example 3 is a non-transitory computer-readable medium storing instructions for determining expert placement layouts for a mixture of experts (MoE) model, the instructions when executed by one or more processors, cause the one or more processors to perform a set of operations comprising receiving a plurality of tokens corresponding to an input prompt; receiving routing information of the plurality of tokens corresponding to at least a subset of a plurality of experts in one MoE layer of a plurality of MoE layers in the MoE model, the routing information including a subset of tokens per expert in the subset of the plurality of experts; determining a respective expert workload for each expert in the at least the subset of the plurality of experts based on the routing information; determining an expert workload distribution with respect to the plurality of experts based on the respective expert workload for each expert in the at least the subset of the plurality of experts; and determining an expert placement layout with respect to a plurality of computing units based on the determined expert workload distribution for the plurality of MoE layers.

As recited in examples, Example 4 is a method of clustering in determining expert placement layouts for a mixture of experts (MoE) model. The method includes receiving a plurality of input prompts; determining a respective expert workload distribution with respect to a plurality of experts for each input prompt of the plurality of input prompts; determining, for a selected layer of a plurality of layers in the MoE model, a respective expert placement layout with respect to a plurality of computing units for each input prompt of the plurality of input prompts based on the respective expert workload distribution; and for every two expert placement layouts of the plurality of expert placement layouts corresponding to at least a part of the plurality of experts, determining a similarity between the every two expert placement layouts of a plurality of expert placement layouts; and clustering the plurality of expert placement layouts into the plurality of layout clusters based on the determined similarity.

As recited in examples, Example 5 is a method of determining a routing for an input prompt. The method includes receiving the input prompt; determining an expert workload distribution with respect to a plurality of experts in a mixture of experts (MoE) model for the input prompt; determining an expert placement layout with respect to a plurality of computing units for the input prompt based on the determined expert workload distribution; comparing the expert placement layout to a plurality of pre-determined expert placement layouts, each pre-determined expert placement layouts being associated with a respective cluster of computing devices in a plurality of computing device clusters; selecting a pre-determined expert placement layout from the plurality of pre-determined expert placement layouts based on the comparison; and routing the input prompt to a target cluster of computing devices corresponding to the selected pre-determined expert placement layout, the target cluster being one of the plurality of computing device clusters.

As recited in examples, Example 6 is a method of dispatching tokens when running a mixture of experts (MoE) model. The method includes receiving a plurality of tokens corresponding to an input prompt; receiving an expert placement layout for a MoE layer of the MoE model, the expert placement layout including an indication of a first set of experts hosted by a first computing unit and an indication of a second set of experts hosted by a second computing unit, the first set of experts including a first expert, the second set of experts including the first expert; determining a token dispatch solution for the plurality of tokens by at least: receiving an indication of a set of tokens to be provided to the first expert in the MoE layer, the set of tokens being a part of the plurality of tokens; determining a first subset of tokens to be provided to the first expert hosted by the first computing unit based at least in part on a number of tokens to be input to other experts in the first set of experts, the first subset of tokens being a subset of the set of tokens; and determining a second subset of tokens to be provided to the first expert hosted by the second computing unit based at least in part on a number of tokens to be input to other experts in the second set of experts, the second subset of tokens being a subset of the set of tokens; dispatching the first subset of tokens to the first expert hosted by the first computing unit; and dispatching the second subset of tokens to the first expert hosted by the second computing unit.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a simplified diagram illustrating a first part of a system for workload balancing, in accordance with embodiments of the subject matter of the disclosure.

FIG. 2 is a simplified diagram illustrating a second part of a system for workload balancing, in accordance with embodiments of the subject matter of the disclosure.

FIG. 3 is a simplified diagram illustrating a third part of a system for workload balancing, in accordance with embodiments of the subject matter of the disclosure.

FIG. 4 is a flow diagram illustrating an exemplary method of prompt routing for workload balancing, in accordance with embodiments of the subject matter of the disclosure.

FIG. 5 is a flow diagram illustrating an exemplary method of determining expert placement layouts, in accordance with embodiments of the subject matter of the disclosure.

FIG. 6 is a flow diagram illustrating an exemplary method of clustering expert placement layouts, in accordance with embodiments of the subject matter of the disclosure.

FIG. 7 is a flow diagram illustrating an exemplary method of routing for input prompts, in accordance with embodiments of the subject matter of the disclosure.

FIG. 8 is a flow diagram illustrating an exemplary method of dispatching tokens when running a mixture of experts (MoE) model, in accordance with embodiments of the subject matter of the disclosure.

FIG. 9 is a simplified block diagram of a computing device and/or a computing system, with which aspects of the present disclosure may be practiced.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

As the terms are used herein with respect to measurements (e.g., dimensions, characteristics, attributes, components, etc.), and ranges thereof, of tangible things (e.g., products, inventory, etc.) and/or intangible things (e.g., data, electronic representations of currency, accounts, information, portions of things (e.g., percentages, fractions), calculations, data models, dynamic system models, algorithms, parameters, etc.), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error; differences in measurement and/or manufacturing equipment calibration; human error in reading and/or setting measurements; adjustments made to optimize performance and/or structural parameters in view of other measurements (e.g., measurements associated with other things); particular implementation scenarios; imprecise adjustment and/or manipulation of things, settings, and/or measurements by a person, a computing device, and/or a machine; system tolerances; control loops; machine-learning; foreseeable variations (e.g., statistically insignificant variations, chaotic variations, system and/or model instabilities, etc.); preferences; and/or the like.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information.

Conventional systems and methods often use limited algorithms to manage workload imbalance in a mixture of experts (MoE) model. For example, the conventional systems may duplicate hot experts (e.g., a hot expert duplicate), which often results in imbalanced workloads. As such, it is challenging to ensure that such a placement strategy remains effective in a shifting prompt environment.

Various embodiments of the present disclosure can achieve benefits and/or improvement over conventional systems by using systems and methods for expert placement and workload balancing. In some embodiments, benefits include improved efficiency of providing effective and adaptive workload balance (e.g., load balance) approaches that can provide expert placement layouts for serving incoming prompts in dynamic servicing environment, for example, by evaluating and using the expert workload distribution across multiple computing units (e.g., graphical processing units (GPUs), tensor processing units (TPUs), etc.). Additional and/or alternative benefits should be recognized by those of ordinary skill in the art, at least in light of the teachings provided herein.

According to certain embodiments, an expert, also referred to as an expert network or an expert model, refers to an artificial neural network (ANN) designed to solve a specific problem. In some examples, an expert can include a feedforward network, such as a multilayer perceptron (MLP), and can be trained to handle certain types of inputs, include certain layers, and/or generate certain outputs. In some embodiments, one or more selected experts process the input to generate one or more outputs, and the one or more outputs can be combined to produce a combined output.

In some embodiments, a mixture of experts model, also referred to as an MoE model, refers to a machine learning model and/or architecture that includes a plurality of expert networks, also referred to as experts, along with a gating network (e.g., a neural network, a function, a component, etc.) that routes inputs to at least a part of the plurality of expert networks to process inputs. In some embodiments, only a subset of the plurality of experts are activated for an input, which allows an MoE model including the plurality of experts to scale to a large number of parameters while keeping computation efficiency. In certain embodiments, a mixture-of-experts model includes a plurality of layers, including one or more neural network layers and a plurality of mixture-of-expert layers, where a neural network layer includes one or more neural networks.

According to some embodiments, a mixture-of-experts layer, also referred to as an MoE layer or an expert layer, refers to a model layer including one or more expert models (e.g., an MoE model, etc.) and/or other neural networks. In some embodiments, an expert model is referred to as an expert. In certain embodiments, a mixture-of-experts layer includes a plurality of expert models and a gating mechanism that selects a subset of the plurality of expert models to process one or more inputs. In some embodiments, at least some of the plurality of expert models in an MoE layer run in parallel.

In some embodiments, a gating network refers to a neural network or a function that decides, for an input (e.g., tokens etc.), to which one or more experts (e.g., experts in an MoE model, etc.) should be provided. In some embodiments, a gating network acts as a controller that evaluates the input and assigns it to the relevant experts based on learned scores. In certain embodiments, the use of the gating network allows for increased model capacity and improved performance without a proportional increase in computational cost.

In some embodiments, an expert parallelism (EP) technique is applied to distribute experts into multiple computing units (e.g., GPUs, TPUs, etc.), for example, to fit within limited memory thereof (e.g., a GPU memory). In some embodiments, during an inference when expert parallelism (EP) is enabled, the multiple computing units host different subsets of experts, and the placement of experts can be arbitrary. In some examples, in an MoE layer, GPU 0 hosts experts 0-7, GPU 1 hosts experts 8-15, and/or the like.

According to certain embodiments, a method (e.g., workload balancing, etc.) to be used with a mixture of experts (MoE) model is provided to determine an expert placement layout with respect to a plurality of computing units (e.g., GPUs, TPUs, etc.) based on a determined expert workload distribution.

According to some embodiments, a method of clustering used in determining expert placement layouts includes clustering a plurality of expert placement layouts into a plurality of layout clusters based on a similarity between two or more expert placement layouts of a plurality of expert placement layouts.

According to some embodiments, a method of determining an expert placement layout for an input prompt includes comparing an expert placement layout of the input prompt to a plurality of pre-determined expert placement layouts and select a pre-determined expert placement layout from the plurality of pre-determined expert placement layouts based on the comparison.

According to some embodiments, a method of dispatching tokens, for example, to be used in workload balancing, for a mixture of experts (MoE) model includes determining a token dispatch solution for a plurality of tokens corresponding to an input prompt. In certain embodiments, tokens are inputs to machine learning models (e.g., neural networks, expert models, expert neural networks, etc.). In some embodiments, an input prompt is used to generate one or more tokens. In some embodiments, a token dispatch solution for a plurality of tokens is determined by at least determining a first subset of tokens to be provided to the first expert hosted by a first computing unit, and determining a second subset of tokens to be provided to the first expert hosted by a second computing unit.

According to certain embodiments, systems and methods with a two-level routing strategy are provided in workload balancing for a mixture of experts (MoE) model. In some embodiments, the systems and methods first adaptively route an incoming prompt to a suitable computing device of a plurality of computing devices, then perform a token routing within that computing device to ensure workload balance between different computing units of that computing device.

According to certain embodiments, a mixture of experts (MoE) model is designed to make the training process and/or inference process for an MoE model including a plurality of neural networks (e.g., large-scale neural networks) more efficient and/or scalable. In some embodiments, instead of activating all experts for an input, a subset of experts is used (e.g., typically a few experts per token), where an expert is a feedforward network (e.g., like a multiplayer perceptron (MLP), a relatively small feedforward network, etc.), and a gating network decides which experts to activate for a given token. In some embodiments, an expert parallelism (EP) technique is used to distribute experts into multiple computing units (e.g., GPUs, TPUs, etc.) to fit within the limited memory thereof (e.g., a GPU memory). In some embodiments, expert parallelism (EP) refers to a strategy where different experts are hosted by different computing units (e.g., GPUs, TPUs, etc.), and/or tokens are routed to the computing unit(s) (e.g., GPUs, TPUs, etc.) that host the selected expert(s).

According to some embodiments, during an inference process when expert parallelism (EP) is enabled, in a serving framework implementation, a plurality of GPUs can host a different subset of experts and the expert placement can be arbitrary. For example, in an MoE layer, GPU 0 hosts experts 0-7, GPU 1 hosts experts 8-15, and/or the like. Conventional implementations often have limitations. For example, an MoE layer may have hot experts that may receive far more routing traffic than others after the MoE gating network, making some of the GPUs become bottlenecks in a dispatch-compute-gather cycle. Overloaded GPUs not only compute more, but also send/receive more data during an all-to-all communication phase, further amplifying the imbalance.

According to certain embodiments, systems and methods are provided to mitigate workload imbalance. In some embodiments, an approach is to duplicate hot experts and rearrange the expert placement layout across computing units (e.g., GPUs, TPUs, etc.). A duplicated expert may be referred to as an expert “duplicate”, and these terms can be used interchangeably. The present disclosure provides embodiments to ensure that such an expert placement strategy remains effective in a shifting prompt environment (e.g., an environment handling multiple prompts, etc.) and the same expert duplication policy can adapt to different prompts. In certain embodiments, an expert placement refers to assignment of a computing unit for an expert model (e.g., an expert). In some embodiments, an expert placement layout refers to how a plurality of experts are distributed across one or more computing units (e.g., GPUs, TPUs, etc.).

The present disclosure provides embodiments to address at least some limitations in conventional limitations as discussed below. For example, to improve adaptability, conventional implementations may rely on periodically updating the expert-to-GPU placement based on aggregated workload statistics from recent prompts. This approach may have limitations, in certain examples. First, as an example, the aggregated workload statistics cannot capture the per-prompt variability when the inference is performed on individual prompts. In addition, in certain examples, the update assumes temporal locality in prompt distributions that future prompts will resemble those seen during the update window. In some examples, prompt distributions can shift abruptly and unpredictably in shared inference services where users submit a wide variety of prompts that vary dramatically in topic, structure, and intent. In some examples, as a result, a single expert placement layout, once fixed, may become suboptimal, or even counterproductive, for new prompts.

In certain examples, when duplicated experts are placed on different GPUs, token-to-GPU mapping is no longer solely determined by the MoE gating network, which assigns tokens to experts, instead of specific GPU instances. As a result, in some examples, expert workload statistics alone are insufficient to determine the actual token routing. In certain embodiments, an expert workload refers to a number of tokens to be input into an expert (e.g., an expert model, etc.). According to some embodiments in the present disclosure, the routing of tokens to specific copies of duplicated experts across GPUs can be determined to address the problem of overall load balancing, also referred to as workload balancing. In certain embodiments, load balancing, also referred to as workload balancing, refers to assigning tasks (e.g., experts, tokens, etc.) to computing units (e.g., GPUs, TPUs, etc.) that each computing unit can complete in similar amount of time. In contrast, conventional implementations either split tokens evenly between same experts on different GPUs or use a static rule for token dispatch. Either approach of the conventional implementations may fail to adapt to dynamic prompt patterns and cannot even stay compatible with the single expert placement layout solution to balance GPU workload.

According to certain embodiments, systems and methods for effective and empirically adaptive workload balance implementations can provide improved expert placement layouts for serving incoming prompts in a dynamic serving environment. In some embodiments, systems and methods can provide improved (e.g., adaptable, personalized, optimized, etc., for a specific incoming prompt) token routing policies after determining the expert placement layout for incoming prompts with duplicated experts. In some embodiments, the token routing policies are dynamically determined for a specific incoming prompt such that prompt and token routing is adaptable, personalized, and optimized to that specific incoming prompt.

In some embodiments, systems and methods are provided to solve optimal expert placement layouts in terms of balanced workload among computing units or GPUs (or other user defined objectives) based on expert workload distribution determined by a prompt with consideration of duplicated experts. In certain embodiments, an expert workload distribution refers to a distribution of an expert workload of each expert model in a set of expert models (e.g. a set of expert models hosted by one or more computing units, a set of expert models for a layer in an MoE model, etc.).

In some embodiments, systems and methods are provided to cluster expert workload distributions according to their solved optimal expert placement layouts characteristics. In some embodiments, systems and methods are provided to map incoming prompts to their preferred expert placement layouts according to the determined expert workload distributions. In some embodiments, systems and methods are provided to further solve personalized token dispatch rules for each incoming prompt incorporated with the selected expert placement layout.

In some embodiments, an effective solution is provided to cope with the abrupt and unpredictably shifting prompt serving environment for inference acceleration. In some embodiments, systems and methods can provide a guaranteed global optimal solution for solved expert placement layouts and corresponding token routing policy for inference acceleration.

According to certain embodiments, to benefit from using expert parallelism (EP), systems and methods can address relevant issues based on characteristics of an MoE inference, including the uneven GPU load distribution, and the high communication overhead.

In the present disclosure, embodiments of systems and methods can alleviate uneven GPU load distribution problem and consequently reduce high communication overhead. Embodiments of systems and methods have several technical advantages over conventional implementations. For example, existing solution is about getting a single expert placement layout using aggregate statistics on expert workload distribution, for example, which works in an average sense. This conventional approach relies on temporal locality in prompt distributions, which may not be true. In addition, improving expert placement based on aggregated token-level routing statistics also fails to address the per-prompt nature of inference. In practice, inference is performed on individual prompts, each with its own unique expert workload distribution. Layout that works well on aggregated (e.g., average) statistics does not imply satisfied average performance across prompts since there is no correlation between the two. In some examples, an expert placement layout determined for the average case may perform poorly for many specific prompts. In fact, the present disclosure recognized that averaging can obscure workload variance, leading to systematically suboptimal placement decisions.

In the present disclosure, embodiments of systems and methods can address the above issues in the conventional implementations. In some embodiments, systems and methods can cluster expert workload distributions into different clusters and obtain expert placement layout profiles catered to each collection of expert workload distributions. In some embodiments, incoming prompts can be routed to one of the dedicated computing units (e.g., GPUs, TPUs, etc.) using input characteristics. In this way, embodiments of the systems and methods can make sure of better performance by providing a more personalized and robust expert placement layout to prompts instead of a one size fits all solution.

In some embodiments, with consideration of duplicated experts to be shown on different computing units (e.g., GPUs, TPUs, etc.), systems and methods can determine a token routing to specific copies of duplicated experts across GPUs along with the expert placement layout. For example, some tokens are routed to expert 0 in a MoE layer and expert 0 is hosted by both GPU 0 and 1. The respective numbers of tokens to be routed to the expert 0 on GPU 0 and the expert 0 on GPU 0 can be determined.

According to some embodiments, systems and methods are provided to solve expert placement layout given an expert workload distribution and/or an objective, which can achieve more effective workload balance among computing units (e.g., GPUs, TPUs, etc.). In some embodiments, the systems and methods further include the number of tokens provided to specific expert on specific GPU in an MoE layer as decision variables. In some embodiments, the systems and methods can guarantee the feasibility of the solved expert placement layout. In some embodiments, the systems and methods can fill the gap of improving expert placement layouts with expert duplication consideration.

According to some embodiments, systems and methods can address the token dispatch problem introduced by expert duplication. In contrast, existing implementation that supports duplicated experts applies one or more dispatch rules (e.g., trivial dispatch rules, etc.), for example., static and/or random strategy. Using either approach, the conventional solution may be suboptimal as the dispatch rule needs to be related to a specific expert workload distribution, corresponding to an expert placement layout, and/or an objective.

According to certain embodiments, systems and methods can solve token dispatch rules during an inference in a case-by-case manner. In some embodiments, during an inference, after routing incoming prompts to one of the dedicated computing units (e.g., GPUs, TPUs, etc.), the systems and methods can determine an expert placement layout. In some embodiments, systems and methods can provide a reduced version for solving improved expert placement layout that can solve personalized token dispatch rules incorporated by expert workload distribution(s), the corresponding expert placement layout(s) and user defined objective (e.g., represented by an objective function, etc.) to ensure a balanced workload split (e.g., assigning tokens to duplicate experts hosted by different computing units, etc.) among the computing units (e.g., GPUs, TPUs, etc.).

According to certain embodiments, input data (e.g., prompts, tokens, and the like) can be provided to a mixture of experts (MoE) model. The input data is passed to a gating network. In some embodiments, the gating network acts as a router by deciding a subset of a set of experts (e.g., Expert 1, Expert 2, . . . , Expert K) to be activated for processing that specific input data. For example, in some embodiments, the gating network can assign scores to the set of experts and a subset of experts (e.g., top-1 or top-2) is selected based on the scores. In some embodiments, the set of experts are specialized neural networks trained to handle different types of data or tasks. In some embodiments, the selected subset of experts can process the input data, and the outputs of the selected subset of experts can be combined to generate a final output. In some embodiments, all-to-all communication can be used to send tokens to respective computing units (e.g., GPUs, TPUs, etc.) where the selected experts are allocated. In some embodiments, the output can be generated by determining a weighted sum to combine or aggregate outputs from different experts. In some embodiments, a layer in an MoE model has an input of a plurality of tokens. In certain embodiments, a layer in an MoE model includes a set of selected experts hosted by computing units (e.g., GPUs, TPUs, etc.). In some embodiments, the set of selected experts are different for different layers. In some examples, Expert 1 in a first layer is different from Expert 1 in a second layer.

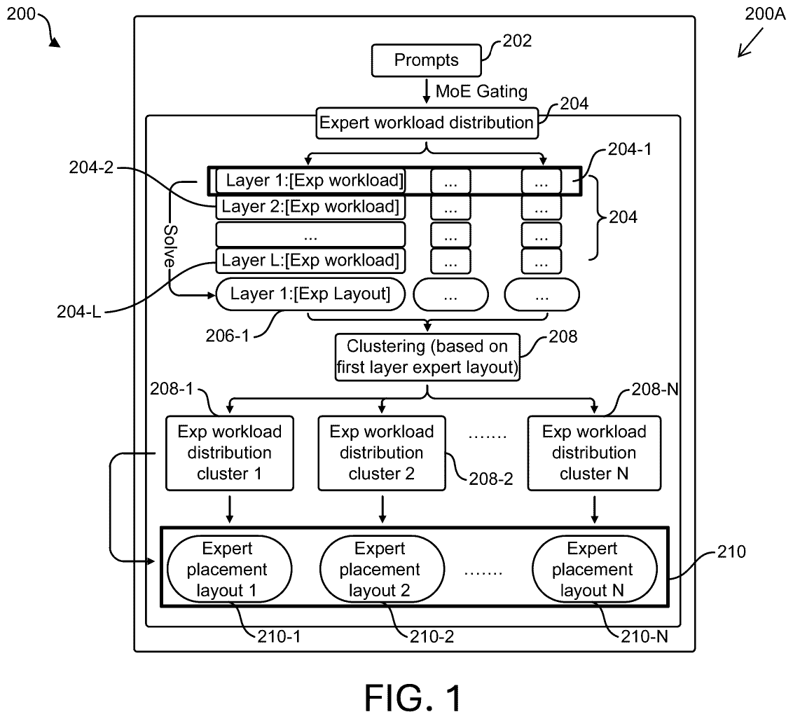

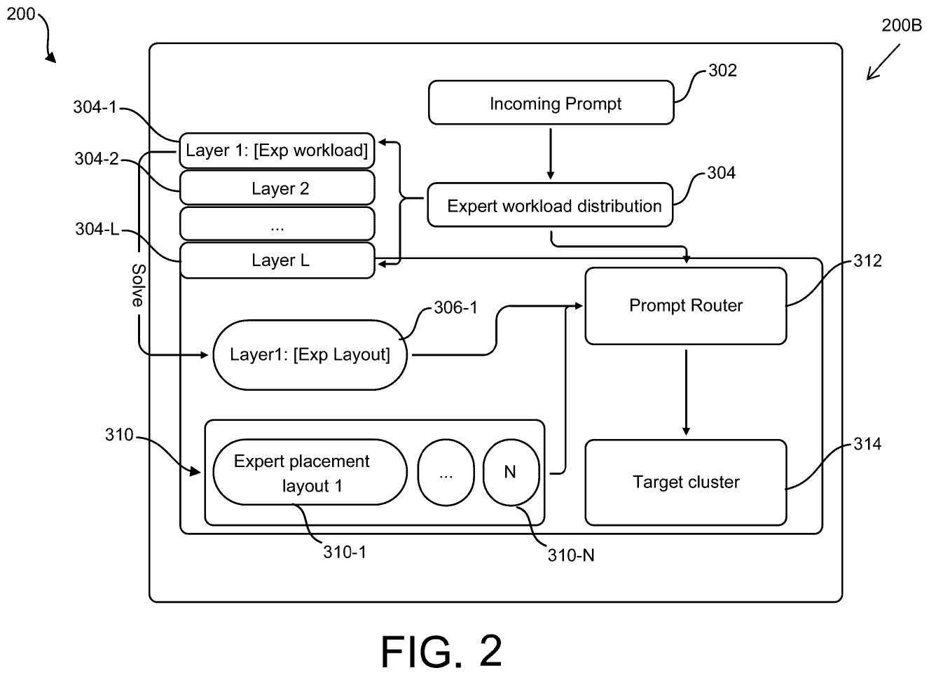

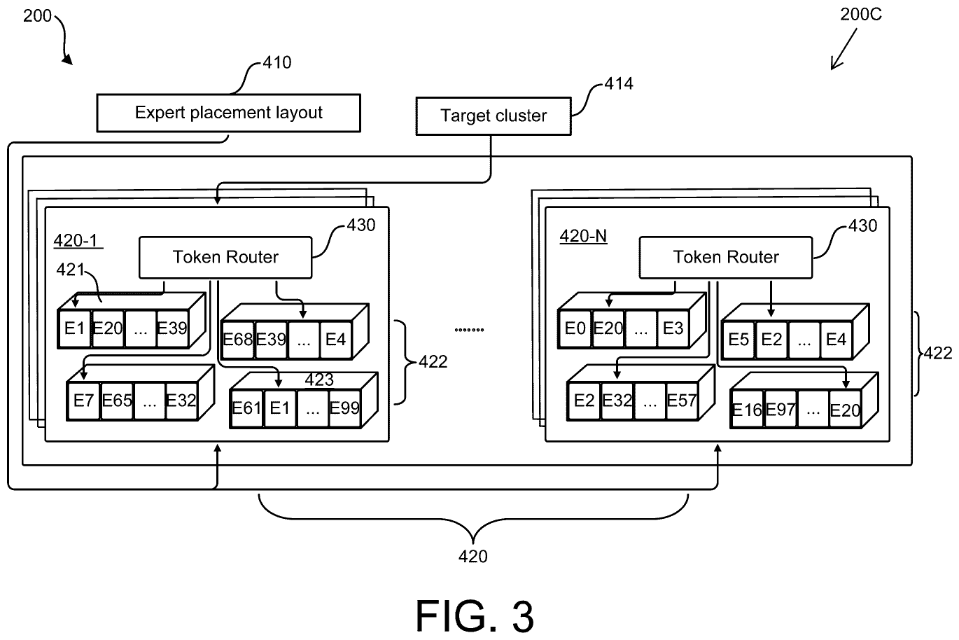

FIG. 1 is a simplified diagram illustrating a first part 200A of a system 200 for workload balancing, in accordance with embodiments of the subject matter of the disclosure. In some embodiments, the first part 200A of the system 200 can be implemented by, for example, a clustering engine for clustering expert workload distributions and expert placement layouts, an expert placement layout engine for determining an expert placement layout, and/or other engines. FIG. 2 is a simplified diagram illustrating a second part 200B of the system 200 for workload balancing, in accordance with embodiments of the subject matter of the disclosure. In some embodiments, the second part 200B of the system 200 can be implemented by, for example, a prompt router engine, and/or other engines. FIG. 3 is a simplified diagram illustrating a third part 200C of the system 200 for workload balancing, in accordance with embodiments of the subject matter of the disclosure. In some embodiments, the third part 200C of the system 200 can include, for example, an inference engine, and/or other engines. In some embodiments, the inference engine can perform a set of operations including token dispatching.

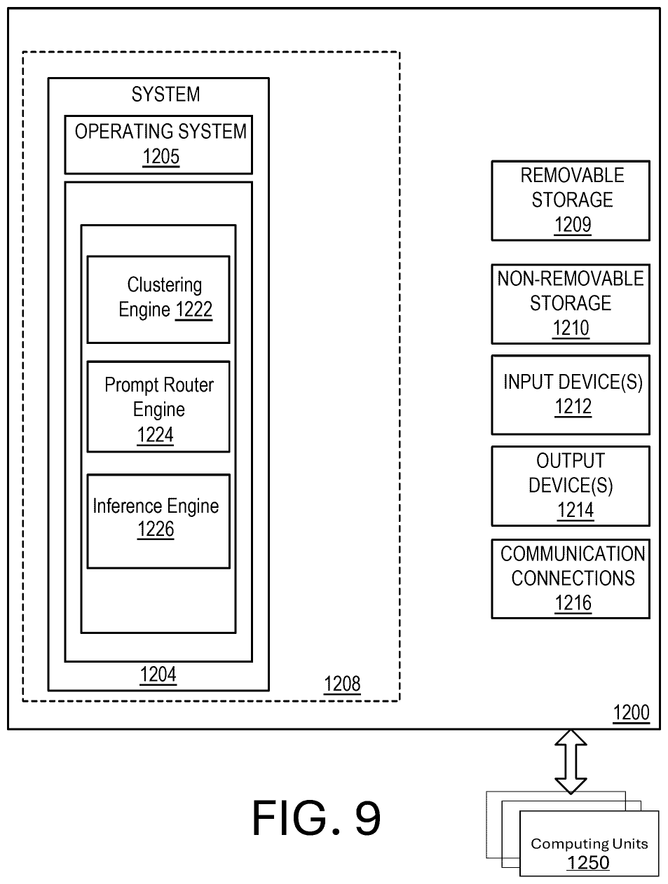

Referring to FIG. 1, in some embodiments, the system (e.g., the system 1200 in FIG. 9) can determine an expert workload distribution 204 for prompts 202. In some cases, the prompts 202 can include random prompts as input prompts for training. In some embodiments, the expert workload distribution 204 includes a first MoE layer expert workload distribution 204-1 for a first MoE layer in a MoE model, a second MoE layer expert workload distribution 204-2 for a second MoE layer in the MoE model, . . . , and a Lth MoE layer expert workload distribution 204-L for the Lth MoE layer in the MoE model.

In some embodiments, the system (e.g., the system 1200 in FIG. 9) can determine the respective expert placement layouts 206-1 for the prompts 202 using the respective selected MoE layer (e.g., first MoE layer) expert workload distributions 204-1. In certain embodiments, an expert workload includes a number of tokens to be provided to and/or handled by one expert of one or more experts that is hosted by a computing unit of the plurality of computing units (e.g., GPUs, TPUs, etc.). An exemplary algorithm to determine an expert workload distribution with respect to the plurality of experts based on the respective expert workload for one expert of the plurality of experts will be described further below.

In some embodiments, the system (e.g., the system 1200 in FIG. 9) can cluster at block 208 the respective selected MoE layer (e.g., first MoE layer) expert workload distributions 204-1 for the prompts 202 into multiple clusters 208-1, 208-2, . . . , 208-N according to certain criteria. In some embodiments, the system uses the expert workload distribution for a selected MoE layer (e.g., a first MoE layer), instead of multiple or all the MoE layers, to solve the corresponding expert placement layout, which is then used for clustering. In some examples, it might be time consuming to solve multiple or all the MoE layers (e.g., 0.05 seconds per MoE layer). In certain embodiments, a relatively fast clustering can be achieved by solving expert placement layouts for a limited number of MoE layers, for example, a selected MoE layer (e.g., a first MoE layer).

In some embodiments, the certain criteria for clustering can include an expert placement layout similarity which can be, for example, a distance measured between the respective expert placement layouts 206-1. In some embodiments, the corresponding selected MoE layer (e.g., first MoE layer) expert workload distributions 204-1 in a cluster share a similar expert placement layout 206-1. In some embodiments, clustering the selected MoE layer (e.g., first MoE layer) expert workload distributions 204-1 can be sufficient without clustering expert workload distributions for other MoE layers (e.g., Layer 2, . . . , Layer L).

In some embodiments, the system (e.g., the system 1200 in FIG. 9) can sample (e.g., randomly sample, algorithmically sample, etc.) an expert workload distribution from each cluster 208-1, 208-2, . . . , 208-N. The sampled expert workload distributions can be used to determine and/or select the respective expert placement layouts 210 (e.g., 210-1, 210-2, . . . , 210-N) for one or more MoE layers, respectively. In some examples, the determined and/or selected expert placement layouts 210-1, 210-2,., 210-N are representative for each cluster 208-1, 208-2, . . . , 208-N because the clustering step ensures expert workload distributions in each cluster can share a similar solved expert placement layout. In some embodiments, the expert placement layouts 210-1, 210-2, . . . , 210-N can include expert placement layouts for multiple or all MoE layers in a MoE model.

Referring to FIG. 3, in some embodiments, the system (e.g., the system 1200 in FIG. 9) can assign dedicated computing units 422 (e.g., GPUs, TPUs, etc.) for a computing device in a cluster (e.g., group, etc.) of computing devices 420-1, . . . , 420-N. For example, denoting N the number of clusters and N=8. In an example, a number of tokens corresponding to an input prompt can be 25, 100, and/or the like. When there are two-hundred (200) computing devices available, the number of dedicated computing devices in the eight (8) clusters can each have 25 computing device respectively, as an example. In some examples, each cluster of computing devices are designated to handle a category of input prompt corresponding to an expert placement layout. In certain examples, a computing device in a cluster has a number of computing units (e.g., 8 GPUS, 32 GPUs, 16 TPUs, etc.). In some examples, a computing device is loaded with an expert placement layout (e.g., a pre-determined expert placement layout, an expert placement layout 210-1, . . . 210-N, etc.), and each computing unit of a plurality of computing units included in a computing device is loaded with a part of the expert placement layout. In certain examples, a computing unit included in a computing device is loaded with a part of an expert placement layout including layouts for a plurality of layers of a ML model (e.g., an MoE model, etc.). For example, a computing unit included in a computing device is loaded with a part of an expert placement layout including layouts for fifty-eight (58) MoE layers of an MoE model such as in a DeepSeek™ R1 model. It is to be understood that an MoE model may have other numbers of MoE layers.

In some embodiments, the system (e.g., the system 1200 in FIG. 9) can load expert weights (e.g., weights in an expert model) according to the respective expert placement layouts 210-1, 210-2, . . . , 210-N for multiple or all MoE layers in the corresponding dedicated clusters of computing devices (e.g., 420-1, . . . , 420-N), where a computing device (e.g., device 420, etc.) includes a plurality of computing units 422. For example, as illustrated in the embodiment of FIG. 3, the system (e.g., the system 1200 in FIG. 9) can load expert weights according to the expert placement layouts 410 in the corresponding clusters 420-1, . . . , 420-N of computing devices each including the computing units 422. In some embodiments, the expert placement layouts 410 can be or include the pre-determined expert placement layouts 210 in FIG. 1.

In some embodiments, the expert placement layouts 210 or 410 can be updated offline periodically based on new data (e.g., a new prompt 202 in FIG. 1, an incoming prompt 302 in FIG. 2, and the like) and the associated clustering results. As more prompts received by the system (e.g., the system 1200 in FIG. 9), the system can update the expert placement layouts 210, 310, 410, which become more representative of the evolving workload distribution (e.g., empirically adaptive, etc.). In some examples, the associated expert placement layout and the number of dedicated computing units (e.g., GPUs, TPUs, etc.) for each cluster can also be updated accordingly.

In some embodiments, an offline update process can use output from the prompt router engine and/or the inference engine and can be executed with a relatively low overhead (e.g., substantially zero overhead), ensuring both operational efficiency and uninterrupted service. In some embodiments, the system (e.g., the system 1200 in FIG. 9) can achieve expert rebalancing by implementing the steps (a), (b) and/or (c) below.

In some embodiments, in step (a), the system 200 can determine the differences (e.g., deltas) between the current and new expert placement layouts. In some embodiments, in step (b), the corresponding new expert weights can be loaded asynchronously onto the GPUs using direct memory access (DMA) engines, reducing or minimizing latency and avoiding compute interference. In some embodiments, in step (c), the current expert weights can be replaced with the new expert weights using device-to-device memory copies or physical memory rebindings, ensuring fast and efficient transitions. In some embodiments, the above steps (b) and (c) are repeated for multiple iterations until the new expert placement layout is fully deployed across multiple or all computing units (e.g., GPUs, TPUs, etc.) in the system (e.g., the system 1200 in FIG. 9).

In some embodiments, for each incoming prompt 302 in FIG. 2, the system 200B (e.g., a prompt router engine, etc.) first runs through an MoE gating network to get expert workload distributions 304 for one or more MoE layers. In some embodiments, certain selected MoE layer expert placement layout can be solved based at least on the respective selected MoE layer expert workload distribution. In some embodiments, the first MoE layer expert placement layout 306-1 can be solved based at least on the first MoE layer expert workload distribution 304-1.

In some embodiments, the prompt router 312 includes a workload balancer that can calculate a similarity score between the expert placement layout 306-1 of the selected MoE layer (e.g., a first MoE layer) for the new prompt 302 and one of the pre-determined expert placement layouts 310 (e.g., Expert placement layout 1 310-1, . . . , Expert placement layout N 310-N) of the selected MoE layer (e.g., first MoE layer). In some examples, the expert placement layouts 310 are the same as expert placement layouts 210. In some embodiments, the expert placement layouts 310 can be pre-determined expert placement layouts. In some embodiments, the expert placement layouts 310 can include, for example, the expert placement layouts 210-1, 210-2, . . . , 210-N in FIG. 1 for the selected MoE layer (e.g., a first MoE layer).

According to certain embodiments, the system (e.g., the system 1200 in FIG. 9) determines (e.g., calculates, etc.) a plurality of similarities scores, where a similarity score is a similarity score between the expert placement layout 306-1 and one of the expert placement layouts 310 (e.g., the expert placement layout 310-1, . . . the expert placement layout 310-N). In some embodiments, the plurality of similarity scores can be ranked and the prompt 302 can be routed to computing units (e.g., GPUs, TPUs, etc.) of a target cluster 314 based on the ranking. In some embodiments, the target cluster 314 can be or include the target cluster 414 selected from the clusters 420-1, . . . , 420-N in FIG. 3. In some examples, the selected target cluster 414 can be a cluster having the highest similarity score, and if not available to a cluster of a second highest similarity score. In some embodiments, when all dedicated computing devices in the target cluster 314 (e.g., one of the clusters 420-1, . . . , 420-N in FIG. 3) are busy, the prompt 302 can be routed to one of the other clusters according to the similarity score rank. In some embodiments, after having the routing result, the token dispatch result can be calculated given an expert placement playout using a token routing algorithm.

According to some embodiments, an exemplary algorithm to (i) determine an expert workload distribution with respect to the plurality of experts based on the respective expert workload for an expert of the plurality of experts and (ii) dispatch tokens to experts hosted by different computing units (e.g., GPUs, TPUs, etc.) will be described below. It is to be understood that the exemplary algorithm below illustrates one example of implementing methods of expert placement and token dispatches for a mixture of experts (MoE) model. Similar algorithms can be implemented to achieve the same or similar functions.

In certain embodiments, the system (e.g., the system 1200 in FIG. 9) determines an expert placement layout for an MoE layer of the MoE model. In some embodiments, the expert placement layout is determined based on at least one selected from a group consisting of a number of tokens to be provided to an expert hosted by a computing unit for an expert in the one MoE layer, a number of experts hosted by the computing unit, a maximum number of experts hosted by the computing unit, and an expert workload for the one MoE layer, and/or the like. In certain embodiments, the expert placement layout is determined using one or more functions including one or more variables including at least one selected from a group consisting of a number of tokens to be provided to an expert hosted by a computing unit for an expert in the one MoE layer, a number of experts hosted by the computing unit, a maximum number of experts hosted by the computing unit, and an expert workload for the one MoE layer, and/or the like. In some embodiments, the expert placement layout is determined using one or more functions including one or more variables including a number of tokens to be provided to an expert hosted by a computing unit for an expert in the one MoE layer, a number of experts hosted by the computing unit, a maximum number of experts hosted by the computing unit, and an expert workload for the one MoE layer, and/or the like.

In some embodiments, for a single node (e.g., a computing device including multiple computing units such as, e.g., GPUs, TPUs, etc.), operation parameters can be defined as follows:
E ∈Z+: number of experts;
G ∈Z+: number of computing units (e.g., GPUs, TPUs, etc.);
L ∈Z+: number of MoE layers;
Wₑₗ ∈Z+: total workload of expert e in MoE layer I;
x_{egl} ∈{0, 1}: binary variable; 1 if expert e is placed on the computing unit g in MoE layer l;
y_{egl} ∈Z+: number of tokens handled by the computing unit g for expert e in layer I;
z_{gl} ∈Z+: workload of the computing unit g at MoE layer I;
zₘₐₓ, zₘᵢₙ ∈Z+: max and min expert workload at MoE layer I, constant after given the expert workload of prompt;
m ∈Z+: number of experts per MoE layer per computing unit.

In some embodiments, an objective of the exemplary algorithm (e.g., an objective function, etc.) can be user-defined. In an example, an objective function is to find x_{egl} to reduce or minimize (zₘₐₓ-zₘᵢₙ) for the MoE layer I with respect to at least constraints below:

$${\sum }_{g = 1}^{G} {x}_{e g l} \geq 1 , ∀ e ∈ \{ 1 , … , E \} , l ∈ \{ 1 , … , L \} \qquad ( A1 )$$

$${\sum }_{e = 1}^{E} {x}_{e g l} = m , ∀ g ∈ \{ 1 , … , G \} , l ∈ \{ 1 , … , L \} \qquad ( A2 )$$

$$m \leq M \qquad ( A3 )$$

$${\sum }_{g = 1}^{G} {y}_{e g l} = {W}_{e l} , ∀ e ∈ \{ 1 , … , E \} , l ∈ \{ 1 , … , L \} \qquad ( A4 )$$

$${y}_{e g l} \leq {W}_{e l} \cdot {x}_{e g l} , ∀ e ∈ \{ 1 , … , E \} , g ∈ \{ 1 , … , G \} , l ∈ \{ 1 , … , L \} \qquad ( A5 )$$

$${y}_{e g l} \geq {x}_{e g l} , ∀ e ∈ \{ 1 , … , E \} , g ∈ \{ 1 , … , G \} , l ∈ \{ 1 , … , L \} \qquad ( A6 )$$

$${z}_{g l} = {\sum }_{e = 1}^{E} {y}_{e g l} ∀ g ∈ \{ 1 , … , G \} , l ∈ \{ 1 , … , L \} \qquad ( A7 )$$

$${z}_{g l} \leq {z}_{l}^{max} ∀ g ∈ \{ 1 , … , G \} , l ∈ \{ 1 , … , L ) \qquad ( A8 )$$

$${z}_{g l} \geq {z}_{l}^{min} ∀ g ∈ \{ 1 , … , G \} , l ∈ \{ 1 , … , L \} ) \qquad ( A9 )$$

where (A1) indicates that every expert e is hosted by at least one computing unit (e.g., GPU); (A2) indicates the number of experts (m) hosted by each computing unit is the same; (A3) indicates that the number of experts hosted by each computing unit is limited to (e.g., smaller than and/or equal to M, etc.) avoid potential memory issues; (A4) indicates token assignments sum to total workload; (A5) indicates the token assignment only where expert is placed and the number is bounded by the total number of tokens routed to expert e in layer I; (A6) indicates every expert placement to carry at least one token (otherwise the weight does not have to be loaded); (A7) indicates that workload of computing unit g at layer I equals the total expert workload on that computing unit after the workload splits among the expert duplicates, also referred to as expert duplicates, in the layer I; and/or (A8) and (A9) introduce the min and max workload among all the computing units at layer I and the solver searches for possible decision variables (e.g., x and y, or other decision variables that determine a solution for expert placement layouts) that satisfies all these inequalities such that the objective function can be minimized. In some examples, the inequalities can be certain constraints which are parts of a mathematical program other than the objective function.

In some embodiments, the above exemplary algorithm can be implemented to balance the workload with sufficient experts while considering the memory issues caused by too many experts with a penalty term. In some embodiments, the penalty term can be represented by (a·m), where m indicates the number of experts, and a indicates a correspondingly defined parameter. In some examples, a is a hyperparameter for penalty. In an example, a relatively large m indicates relatively more experts and potentially better workload balance and may require more memory as a tradeoff.

In certain embodiments, using the exemplary algorithm and/or other workload balancing algorithm described in the present disclosure, a first computing unit of the plurality of computing units hosts a first set of experts and has a first total workload, where the first total workload is an aggregated workload of expert workloads of the first set of experts. In some embodiments, a second computing unit of the plurality of computing units hosts a second set of experts and has a second total workload, where the first total workload is an aggregated workload (e.g., using a sum function, etc.) of expert workloads of the first set of experts. In some embodiments, a difference between the first total workload and the second total workload is less than ten percent (10%) of the first total workload. In some embodiments, a total workload for a computing unit refers to an aggregate (e.g., sum, weighted sum, etc.) of one or more expert workloads corresponding to one or more experts hosted by the computing unit. In some examples, using the exemplary algorithm and/or other workload balancing algorithm described in the present disclosure, a difference between the first total workload and the second total workload is less than a threshold (e.g., 50%, 25%, 20%, 10%, 5%, etc.) of the first total workload. In certain embodiments, the workload balancing solution is obtained based on the constraints and/or an objective function. In some embodiments, the system determines the workload balancing solution using the objective function.

In some embodiments, as shown in FIG. 3, a set of input tokens can be dispatched by respective token routers 430 to the one or more GPUs 422 of computing devices in the clusters 420-1, . . . , 420-N. In some embodiments, a gating network (not shown) can determine which expert(s) to process the set of input tokens based on, for example, a content of the respective tokens. In some embodiments, tokens can be redistributed across the GPUs 422 and each token can be sent to the respective expert that is hosted by a respective GPU selected by the gating network. In some embodiments, the one or more GPUs 422 can contain (e.g., host, run, etc.) one or more experts (e.g., 8 experts, etc.) to process the tokens they received. It is to be understood that, in some embodiments, each token is processed only by its assigned expert, not all experts, which is the sparse activation principle of mixture of experts (MoE), for example, only a few experts are active per sets of input tokens. In some embodiments, after processing, tokens can be sent back to their respective original or designated GPUs through an all-to-all communication. In some embodiments, the one or more GPUs 422 can collect the respective processed tokens and aggregates them to produce the respective final outputs. For example, in some instances, outputs are labeled to match their original tokens (e.g., Output 1 corresponds to Token 1).

FIG. 3 illustrates the respective expert placement layouts being loaded to the clusters (e.g., groups) of computing devices 420-1, . . . , 420-N, showing how different experts (e.g., expert models with different functionalities, etc.) are distributed or allocated across multiple GPUs (e.g., GPUs 422) in a computing device in the respective cluster 420-1, . . . , 420-N. In the illustrated embodiment, one cluster of the respective clusters 420-1, . . . , 420-N include one or more computing devices, where a computing device includes one or more computing units (e.g., GPU 0 to GPU 3). In some embodiments, one GPU of the GPUs 422 can load expert placement layout for multiple MoE layers (e.g., “Layer 0”, “Layer 1”, and the like), each hosting a subset of experts identified by unique IDs (e.g., “E1”, “E20”, . . . “E39” and the like). In certain examples, loading an expert onto a computing unit (e.g., GPU, TPU, etc.) refers to loading expert weights onto the computing unit. For example, in a computing device in the cluster 420-1, one GPU 421 hosts “E1”, “E20”, . . . “E39” for a selected MoE layer, while another GPU 423 hosts Experts “E61”, “E1”, . . . “E99” for the same selected MoE layer.

In some embodiments, the plurality of computing units (e.g., GPUs, TPUs, etc.) in a computing device of a cluster of computing devices can host substantially the same number of experts. In some examples, a computing device in a cluster (e.g., clusters 420-1, . . . , 420-N) can host, for example, 256 experts in a MoE layer in a MoE model. In some examples, when a computing device includes, for example, 8 GPUs, each GPU can host 32 experts. In some embodiments, a hot expert can have one or more duplicates (e.g., a hot expert duplicate). In one example, when 32 hot expert duplicates are added to the 256 experts in a MoE layer in a MoE model, each GPU can host 36 experts. It is to be understood that a hot expert and its duplicate(s) are allocated in different computing units (e.g., GPUs, TPUs, etc.).

According to some embodiments, a token router 430 is configured to dispatch a plurality of tokens corresponding to an input prompt based at least in part on an expert placement layout for an input prompt. In certain embodiments, the token router 430 receives and/or accesses an expert placement layout for a MoE layer of a MoE model. In some embodiments, the expert placement layout includes an indication of a plurality of sets experts to be hosted by a plurality of computing devices respectively, for example, a computing device to host a set of experts. In some embodiments, the expert placement layout includes an indication of a first set of experts hosted by a first computing unit and an indication of a second set of experts hosted by a second computing unit. In some embodiments, the first set of experts includes a first expert, and the second set of experts includes the first expert (e.g., an expert duplicate).

In some embodiments, the token router 430 receives an indication of a set of tokens to be provided to the first expert in the MoE layer. In some embodiments, the set of tokens (e.g., 150 tokens, etc.) is a part of the plurality of tokens (e.g., 2000 tokens, etc.) corresponding to the input prompt and/or for an MoE layer. In some embodiments, the token router 430 determines a token dispatch solution for the plurality of tokens by determining a first subset of tokens to be provided to the first expert hosted by the first computing unit based at least in part on a number of tokens to be provided to other experts in the first set of experts. In some embodiments, the first subset of tokens is a subset of the set of tokens to be provided to the first expert in the MoE layer. In some embodiments, the token router 430 determines the token dispatch solution for the plurality of tokens by determining a second subset of tokens to be provided to the first expert hosted by the second computing unit based at least in part on a number of tokens to be input to other experts in the second set of experts. In some embodiments, the second subset of tokens is also a subset of the set of tokens to be provided to the first expert in the MoE layer. In some examples, the set of tokens to be provided to the first expert in the MoE layer can be separated (e.g., split) into two or more subsets (e.g., three subsets, four subsets, etc.).

In some embodiments, the token router 430 dispatches the first subset of tokens to the first expert hosted by the first computing unit, and dispatches the second subset of tokens to the first expert hosted by the second computing unit. In some embodiments, the sum of the first subset of tokens and the second subset of tokens is a total number of the set of tokens as input provided to the first expert hosted by the first computing unit and the second computing unit. In some embodiments, the set of tokens as input provided to a first expert can be split into a first subset of tokens to the first expert hosted by a first computing unit, a second subset of tokens to the first expert hosted by a second computing unit, and a third subset of tokens to the first expert hosted by a third computing unit. The sum of the first subset of tokens, the second subset of tokens, and the third subset of tokens is a total number of the set of tokens as input provided to the first expert hosted by the first computing unit, the second computing unit, and the third computing unit.

In some embodiments, an expert placement layout, such as the exemplary expert placement layout illustrated in FIG. 3, enables efficient parallel processing by ensuring that different experts are spread across computing units (e.g., GPUs, TPUs, etc.), allowing tokens to be routed to the appropriate computing units for expert computation while balancing the computational load across the system (e.g., the system 1200 in FIG. 9).

In some embodiments, an MoE model can have multiple MoE layers. For example, a MoE model can (e.g., a DeepSeek™ R1 model, etc.) have sixty-one (61) layers including fifty-eight (58) MoE layers. If full expert placement layouts for all MoE layers are solved to do the clustering with the full matrix, in certain examples, noise and confusion can be introduced. In some examples, one or more tokens routing to one or more experts in one layer tend to be similar to patterns of routing to experts in subsequent layers. In some embodiments, there is no need to do clustering with the full expert placement layout. Instead, redundant information can be removed, and only the solved expert placement layout for the first MoE layer is used for clustering. In some embodiments, the clustering methods can group different prompts based on the respective solved expert placement layouts. In some embodiments, during the inference process, different prompts can be routed using the respective solved expert placement layouts according to the respective expert workload distributions of the incoming prompts. As a result, in some embodiments, an additional step can be added after getting expert placement layouts to group expert workload distributions that prefer similar expert placement layouts. It is to be understood that expert workload distributions are relatively hard to cluster, and the elements are not at the same scale with different prompts.

In some embodiments, methods and systems can cluster first MoE layer expert workload distributions into several clusters according to expert placement layout using historical data. In some embodiments, the number of clusters can be determined by the number of available computing units (e.g., GPUs, TPUs, etc.) and the preliminary data analysis results. In some embodiments, K-Medoids is used with Hamming distance as metric. In some examples, placement equivalence under GPU permutation can be ensured.

In some embodiments, for a prompt, systems and methods can take the first MoE layer workload distribution (e.g., dimension=1*256), and solve the expert placement layout. In some embodiments, the expert placement layouts can be clustered into several layout clusters (e.g., clusters 420-1, . . . , 420-N in FIG. 3), where within each layout cluster can have some shared similarities between the layouts. For example, the expert placement layouts are considered exchangeable as their expert-to-GPU mappings are substantially the same.

In some embodiments, systems and methods can get one representative sample expert workload distribution from each cluster of expert workload distributions and solve a complete or full representative placement layout using expert workload distribution data for each cluster for a part of or all MoE layers. In this manner, representative expert placement layout clusters can be determined for all MoE layers. In some embodiments, the complete or full representative expert placement layout for all MoE layers can be adaptive to every prompt belonging to that cluster.

In some embodiments, a prompt router serves as a load balancer that can obtain a complete or full representative expert placement layout from the representative expert placement layout clusters for a new prompt and to route the new prompt to the corresponding cluster of computing devices based on the obtained representative expert placement layout. In some embodiments, a representative expert placement layout for a selected MoE layer can be used to obtain the complete or full representative expert placement layout. In some embodiments, a similarity score can be calculated between a first MoE layer expert placement layout for the new prompt and the representative first MoE layer expert placement layout. In some cases, when calculating similarity scores (Hamming distance), placement equivalence under GPU permutation can be ensured. For example, the similarity score can be ranked, and the new prompt can be routed to the cluster of computing devices with the highest similarity score. In some embodiments, when all dedicated computing devices in the cluster are busy, the new prompt can be routed to one of the other clusters according to the similarity score rank. It is to be understood that, in some embodiments, using only the first MoE layer workload distribution enables faster prompt routing.

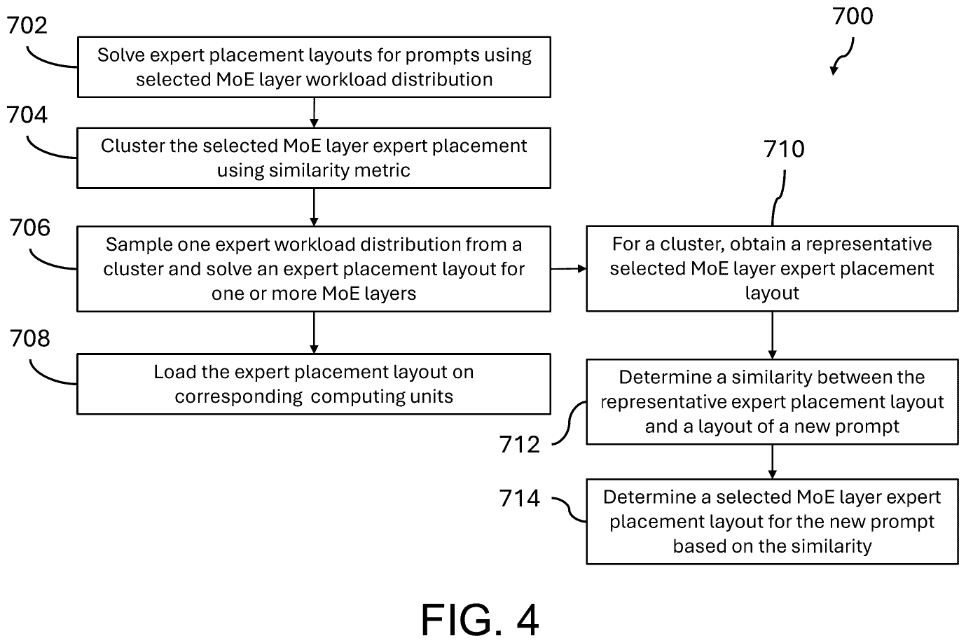

FIG. 4 is a flow diagram illustrating an exemplary method 700 of prompt routing for workload balancing, in accordance with embodiments of the subject matter of the disclosure. The method 700 includes processes 702, 704, 706, 708, 710, 712, and 714. Although the above has been shown using a selected group of processes for the method 700, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 700 are performed by a system (e.g., the computing system 1200 in FIG. 9). In certain examples, some or all processes (e.g., steps) of the method 700 are performed by a computer and/or a processor directed by a code. In some examples, some or all processes (e.g., steps) of the method 700 are performed according to instructions included by a non-transitory computer-readable medium (e.g., in a computer program product, such as a computer-readable flash drive). For example, a non-transitory computer-readable medium is readable by a computer.

According to some embodiments, at process 702, the system (e.g., the system 1200 in FIG. 9) solves expert placement layouts for respective input prompts using a selected MoE layer workload distribution. In some embodiments, an expert workload distribution with respect to a plurality of experts for the input prompt can be determined based on received routing information for the input prompts. In some embodiments, the expert placement layout with respect to a plurality of computing units can be determined based on an expert workload distribution for the input prompt. In some embodiments, the selected MoE layer can be a first MoE layer in an MoE model.

In some embodiments, at process 704, the system (e.g., the system 1200 in FIG. 9) clusters the solved first MoE layer expert placement layouts for the input prompts using similarity metric. For example, in some embodiments, the system can calculate a similarity score between the solved first MoE layer expert placement layouts, and cluster the layouts into different clusters based on the calculated similarity scores. In some embodiments, the respective expert workload distributions can be clustered according to the clusters of expert placement layouts.

In some embodiments, at process 706, the system (e.g., the system 1200 in FIG. 9) samples one expert workload distribution from a cluster of the expert workload distributions. In some embodiments, the sampled expert workload distributions can be used to solve the expert placement layout for one or more MoE layers that is representative for the respective cluster. In some embodiments, the system can solve a full expert placement layout for all MoE layers based on the sampled expert workload distributions. In some embodiments, the solved expert placement layout is representative for the respective cluster.

In some embodiments, at process 708, the system (e.g., the system 1200 in FIG. 9) loads expert placement layouts on the corresponding dedicated computing units. For example, in the embodiment depicted in FIG. 3, the expert placement layouts show how experts are allocated across multiple GPUs within the respective computing devices of the clusters (e.g., clusters 420-1, . . . 420-N, and the like).

In some embodiments, at process 710, the system (e.g., the system 1200 in FIG. 9) obtains a representative selected MoE layer expert placement layout for certain cluster. In some examples, the selected MoE layer can be a first MoE layer in an MoE model. For example, in some embodiments, as shown in FIG. 3, the system can obtain a representative first MoE layer expert placement layout for the respective clusters 420-1, . . . 420-N.

In some embodiments, at process 712, the system (e.g., the system 1200 in FIG. 9) determines a similarity between the representative expert placement layout and an expert placement layout of a new prompt. In some examples, the similarity is determined for a selected MoE layer in a MoE model, e.g., a first MoE layer.

In some embodiments, for a cluster, the system (e.g., the system 1200 in FIG. 9) obtains a data pair of the selected MoE layer workload distribution and the representative selected MoE layer expert placement result. In some embodiments, the system (e.g., the system 1200 in FIG. 9) uses the data pair to train a classifier from the first MoE layer workload to the expert placement result. In some embodiments, the system (e.g., the system 1200 in FIG. 9) uses the trained classifier as a prompt router during inference.

In some embodiments, at process 714, the system (e.g., the system 1200 in FIG. 9) determines a selected MoE layer expert placement layout for the new prompt based on the determined similarity, for example, during an inference process. In some embodiments, a prompt router can compare an expert placement layout of an input prompt to a plurality of pre-determined expert placement layouts. The pre-determined expert placement layouts can be associated with a respective cluster of computing devices. In some embodiments, the prompt router can select a pre-determined expert placement layout from the plurality of pre-determined expert placement layouts based on the comparison.

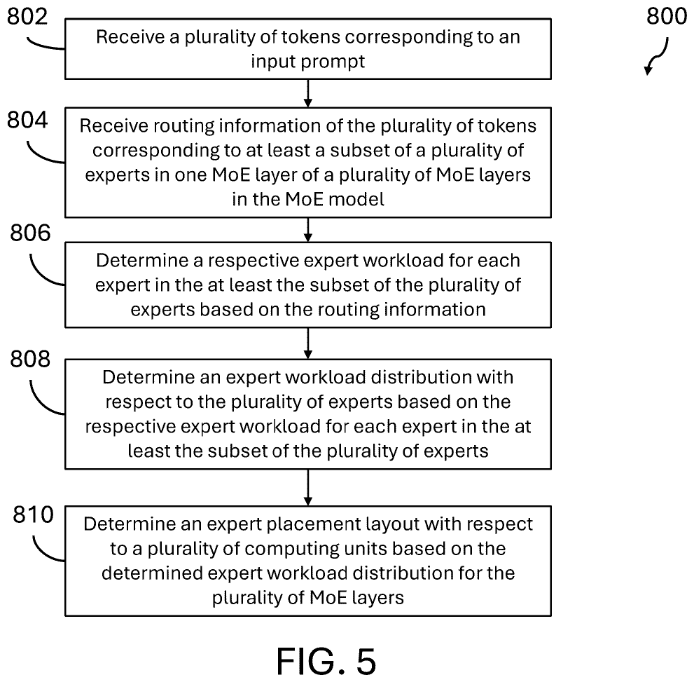

FIG. 5 is a flow diagram illustrating an exemplary method 800 of determining expert placement layouts, in accordance with embodiments of the subject matter of the disclosure. The method 800 includes processes 802, 804, 806, 808, and 810. Although the above has been shown using a selected group of processes for the method 800, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 800 are performed by a system (e.g., or the computing system 1200 in FIG. 9). In certain examples, some or all processes (e.g., steps) of the method 800 are performed by a computer and/or a processor directed by a code. In some examples, some or all processes (e.g., steps) of the method 800 are performed according to instructions included by a non-transitory computer-readable medium (e.g., in a computer program product, such as a computer-readable flash drive). For example, a non-transitory computer-readable medium is readable by a computer.

According to some embodiments, at process 802, the system (e.g., the system 1200 in FIG. 9) receives a plurality of tokens for an input prompt. In some embodiments, a tokenizer associated with specific models can be used to convert an input prompt to one or more tokens. In some examples, a token can be a word, a sub-word, a character, and the like.

In some embodiments, at process 804, the system (e.g., the system 1200 in FIG. 9) receives routing information of the plurality of tokens corresponding to at least a subset of a plurality of experts in one MoE layer of a plurality of MoE layers in the MoE model. In some embodiments, the routing information includes a subset of tokens per expert in the subset of the plurality of experts. In some embodiments, an expert of the plurality of experts includes a feedforward neural network (FFN).

In some embodiments, at process 806, the system (e.g., the system 1200 in FIG. 9) determines a respective expert workload for an expert of the plurality of experts based on the routing information. In some embodiments, the respective expert workload for a respective expert of the plurality of experts includes the number of tokens associated with the respective expert.

In some embodiments, at process 808, the system (e.g., the system 1200 in FIG. 9) determines an expert workload distribution with respect to the plurality of experts based on the respective expert workload for an expert of the plurality of experts. In some embodiments, the respective expert workload for a respective expert of the plurality of experts is indicated by the number of tokens associated with the respective expert. In some examples, an expert workload distribution with respect to experts (e.g., Experts E1 to E12) includes a series of numbers of tokens associated with the respective expert. In an example, a first MoE layer (e.g., “Layer 0”) expert workload distribution with respect to Experts E1 to E12 can be [175, 132, 40, 61, 104, 95, 39, 2, 73, 56, 183, 86]. For example, Expert E1 has a workload of 175 tokens for Layer 0. In an example, a second MoE layer (e.g., “Layer 1”) expert workload distribution with respect to Experts E1 to E12 can be [20, 107, 104, 64, 19, 197, 187, 152, 172, 86, 16, 27]. For example, Expert E5 has a workload of 197 tokens for Layer 1.

In some embodiments, at process 810, the system (e.g., the system 1200 in FIG. 9) determines an expert placement layout with respect to a plurality of computing units based on the determined expert workload distribution. For example, in the embodiment depicted in FIG. 3, the expert placement layouts for the respective clusters 420-1, . . . , 420-N show how experts are allocated across multiple GPUs within the respective clusters 420-1, . . . 420-N. The expert placement layouts can be determined based on the expert workload distributions with respect to the experts discussed above for a selected MoE layer (e.g., “Layer 0”, “Layer 1”, and the like).

In some embodiments, the determining an expert placement layout with respect to the multiple computing devices based on the determined expert workload distribution further includes determining the expert placement layout to balance a first total workload of a first computing unit of the plurality of computing units and a second total workload of a second computing unit of the plurality of computing units. In some embodiments, a total workload for a computing unit refers to an aggregate (e.g., sum, etc.) of one or more expert workloads corresponding to one or more experts hosted by the computing unit for a MoE layer of an MoE model.

In some embodiments, at least one expert of the plurality of experts is hosted in a first computing unit of the plurality of computing units and a duplicate of the at least one expert is hosted in a second computing unit of the plurality of computing units. In some embodiments, the system (e.g., the system 1200 in FIG. 9) splits the expert workload of the at least one expert into the first computing unit and the second computing unit. In some embodiments, the system determines one or more hot experts, where each has a high expert workload. In certain embodiments, the system splits a high expert workload of a hot expert into two or more expert workloads of the hot expert hosted by and/or to be activated on two or more computing units, which is referred to as expert parallelism. In some embodiments, a high expert workload refers to an expert workload that meets one or more criteria. In certain embodiments, the one or more criteria include the highest number of expert workloads. For example, an MoE layer includes 12 experts (E0, E1, . . . . E11) with expert workloads [90, 142, 40, 61, 104, 165, 39, 2, 73, 56, 183, 86], and the system determines to duplicate three experts E1, E5, E10, to generate expert duplicates, also referred to expert duplicates, that has three highest number of expert workloads. As an example, the system splits the high expert workload 183 for expert E10 into two expert workloads (e.g., [90 93], [40 143], [123 60], etc.). In an example, the expert E10 is not a hot expert in a different MoE layer. In some examples, the system can dynamically split a high expert workload into two expert workloads based on an input prompt.

In some embodiments, the expert placement layout includes a number of tokens to be provided to each expert of one or more experts that is hosted by and/or to be activated on a computing unit of the plurality of computing units. For example, as shown in the embodiment of FIG. 3, Expert “E1” and a duplicate of Expert “E1” are allocated in GPU 421 and GPU 423, respectively, for a selected MoE layer (e.g., a first MoE layer). The system (e.g., the system 1200 in FIG. 9) can split expert workload (e.g., 165 tokens) for Expert “E1” for the first MoE layer into Expert “E1” hosted by GPU 421 and Expert “E1” hosted by GPU 423 (e.g., 80 and 85, 5 and 160, 45 and 125, etc.), for example, depending on the expert workload (e.g., the number of tokens) to be handled by other expert(s) hosted by a same GPU.

According to some embodiments, the system splits the expert workload (e.g., a set of tokens) of a first expert into a first computing unit and a second computing unit each hosting a duplicate of the expert. In some embodiments, a first subset of tokens is provided to the first expert hosted by the first computing unit. In some examples, the first subset of tokens is a subset of the expert workload (e.g., a set of tokens) of the first expert. In some examples, a second subset of tokens is provided to the first expert hosted by the second computing unit. In certain examples, the second subset of tokens is a subset of the expert workload (e.g., a set of tokens) of the first expert.

In some embodiments, the first subset of tokens has a first number of tokens, and the second subset of tokens has a second number of tokens. In some embodiments, the first number and the second number of tokens can be determined based at least in part on the respective workload of the first computing unit and the second computing unit. In some embodiments, the system can determine the first number of tokens in the first subset to be more or less than the second number of tokens in the second subset in order to balance the respective total workloads on the first and second computing units.

In some embodiments, the expert workload distribution is for a selected MoE layer of an MoE model (e.g., a first MoE layer such as Layer 0). In some embodiments, the MoE model includes multiple MoE layers. In some embodiments, at least one MoE layer of the multiple MoE layers can include multiple feedforward networks (FFNs). In some embodiments, the determining an expert placement layout includes determining the expert placement layout for the selected MoE layer of an MoE model (e.g., a first MoE layer such as “Layer 0”).

In some embodiments, each computing unit of the multiple computing units hosts a substantially same number of experts according to the expert placement layout. For example, as shown in the embodiment of FIG. 3, each GPU holds multiple experts. It is to be understood that, in some examples, a GPU can hold any suitable number of experts.

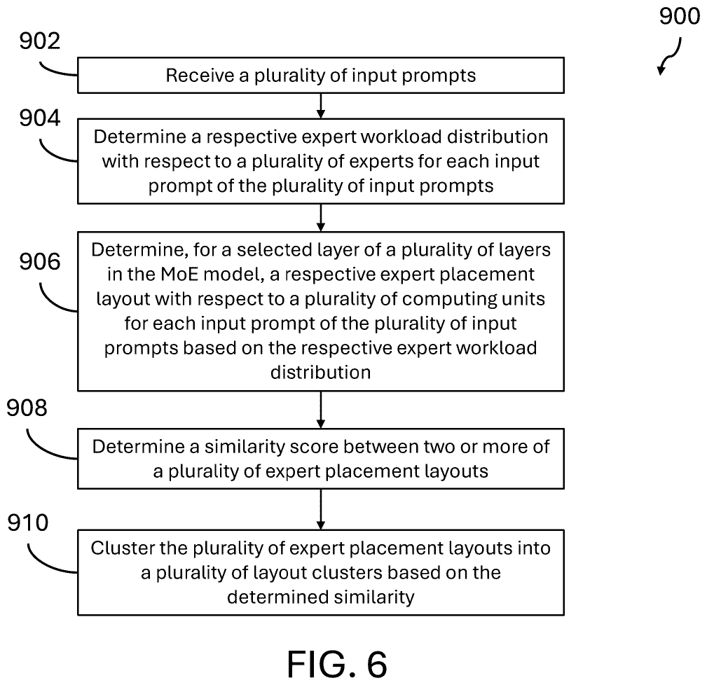

FIG. 6 is a flow diagram illustrating an exemplary method 900 of clustering expert placement layouts, in accordance with embodiments of the subject matter of the disclosure. The method 900 includes processes 902, 904, 906, 908, and 910. Although the above has been shown using a selected group of processes for the method 900, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 900 are performed by a system (e.g., the computing system 1200 in FIG. 9). In certain examples, some or all processes (e.g., steps) of the method 900 are performed by a computer and/or a processor directed by a code. In some examples, some or all processes (e.g., steps) of the method 900 are performed according to instructions included by a non-transitory computer-readable medium (e.g., in a computer program product, such as a computer-readable flash drive). For example, a non-transitory computer-readable medium is readable by a computer.

According to some embodiments, at process 902, the system (e.g., the system 1200 in FIG. 9) receives a plurality of input prompts. In some examples, the input prompts can be one or more prompts received from users. In certain examples, an input prompt can include texts. In some examples, an input prompt can include text and/or media content (e.g., texts, audio, video, images, etc.).

In some embodiments, at process 904, the system (e.g., the system 1200 in FIG. 9) determines a respective expert workload distribution with respect to a plurality of experts for an input prompt of the plurality of input prompts. In some embodiments, the expert workload distributions for the input prompts can be determined by, for example, a gating mechanism (e.g., the gating network 104 in FIG. 1).

In some embodiments, at process 906, the system (e.g., the system 1200 in FIG. 9) determines, for a selected MoE layer of a plurality of layers in the MoE model, a respective expert placement layout with respect to the plurality of computing units for an input prompt of the plurality of input prompts based on the respective expert workload distribution. In some embodiments, the selected layer is a first MoE layer in the MoE model.

In some embodiments, at process 908, for every two expert placement layouts of the plurality of expert placement layouts corresponding to at least a part of the plurality of experts, the system determines a similarity score between the every two expert placement layouts of the plurality of expert placement layouts. In some embodiments, the similarity is determined for the selected layer MoE, e.g., the first MoE layer in the MoE model.

In some embodiments, at process 910, the system (e.g., the system 1200 in FIG. 9) clusters the plurality of expert placement layouts into a plurality of layout clusters based on the determined similarity. For example, first MoE layer layout 1 for prompt 1, first MoE layer layout 3 for prompt 3, and first MoE layer layout 6 for prompt 6 may be grouped into the same group or cluster based on the determined similarity.

In some embodiments, the system (e.g., the system 1200 in FIG. 9) further clusters the respective expert workload distributions into a plurality of expert workload distribution clusters based on the plurality of layout clusters. For example, in the above example, the respective expert workload distributions for prompts 1, 3 and 6 can be grouped into the same group or cluster. In some embodiments, the system (e.g., the system 1200 in FIG. 9) further clusters the input prompts into a plurality of prompt clusters based on the plurality of expert workload distribution clusters. For example, in the above example, prompts 1, 3 and 6 can be grouped into the same group or cluster.

In some embodiments, the clustering of the respective expert placement layouts into a plurality of layout clusters is for the selected MoE layer of an MoE model. For example, in the above example, prompts 1, 3 and 6, the respective expert workload distributions, and the respective first MoE layer expert placement layouts can be grouped into respective same groups or clusters.

In some embodiments, the system (e.g., the system 1200 in FIG. 9) further samples a representative expert workload distribution from the respective expert workload distributions within each distribution cluster of plurality of expert workload distribution clusters. For example, in the above example, a representative expert workload distribution can be sampled from the workload distributions for prompts 1, 3 and 6.

In some embodiments, the system (e.g., the system 1200 in FIG. 9) further determines a representative expert placement layout for a layout cluster of the plurality of layout clusters based on the representative expert workload distribution for each expert workload distribution cluster of the plurality of expert workload distribution clusters. For example, in the above example, a representative expert placement layout can be determined based on the representative expert workload distribution for the cluster of prompts 1, 3 and 6. In some embodiments, the determining the representative expert placement layout is for one or more MoE layers of the MoE model. In certain embodiments, the determining the representative expert placement layout is for a plurality of or all (e.g., 58, etc.) MoE layers of the MoE model. For example, the representative expert placement layout can be the first MoE layer expert placement layout of prompt 3 which represents the cluster of prompts 1, 3 and 6. In some embodiments, the determined representative first MoE layer expert placement layout can be utilized for fast clustering and/or prompt routing.

In some embodiments, the representative expert placement layouts can be determined for multiple or all MoE layers of the MoE model. In some embodiments, the system (e.g., the system 1200 in FIG. 9) further loads a plurality of experts into a plurality of computing units according to the expert placement layout of the plurality of layout clusters for multiple or all MoE layers of the MoE model. For example, in some examples, as shown in FIG. 3, the expert placement layouts 410 are loaded in the corresponding clusters (e.g., groups, etc.) of computing devices 420-1, . . . , 420-N, where a cluster of computing devices include one or more computing devices, and a computing device includes one or more computing units 422. In some embodiments, the system (e.g., the system 1200 in FIG. 9) further updates the respective expert placement layouts within the plurality of layout clusters upon receiving a new input prompt.

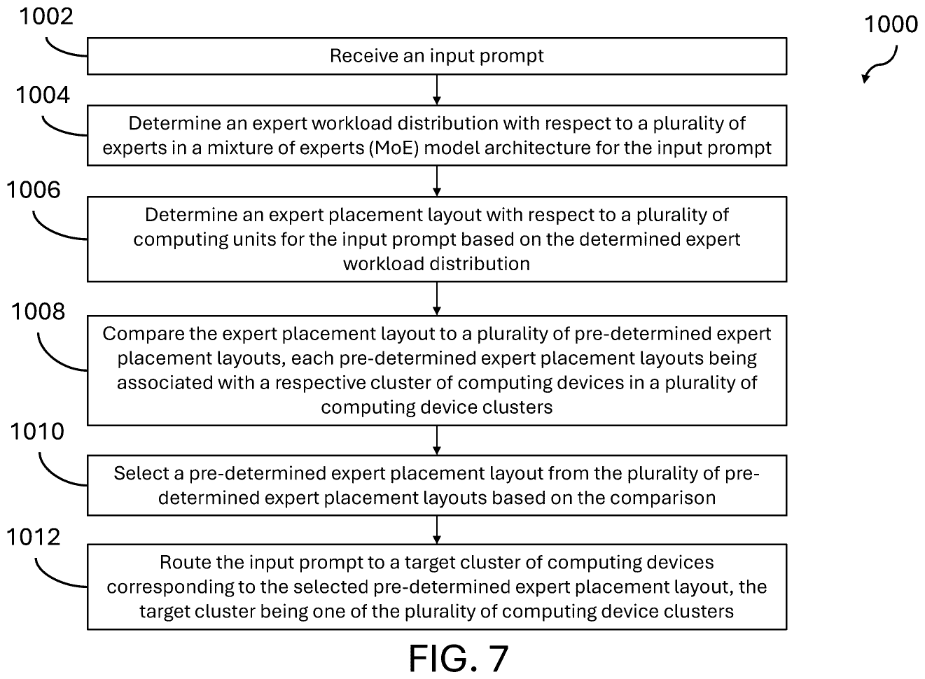

FIG. 7 is a flow diagram illustrating an exemplary method 1000 of routing input prompts, in accordance with embodiments of the subject matter of the disclosure. The method 1000 includes processes 1002, 1004, 1006, 1008, 1010 and 1012. Although the above has been shown using a selected group of processes for the method 1000, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 1000 are performed by a system (e.g., the computing system 1200 in FIG. 9). In certain examples, some or all processes (e.g., steps) of the method 1000 are performed by a computer and/or a processor directed by a code. In some examples, some or all processes (e.g., steps) of the method 1000 are performed according to instructions included by a non-transitory computer-readable medium (e.g., in a computer program product, such as a computer-readable flash drive). For example, a non-transitory computer-readable medium is readable by a computer.

According to some embodiments, at process 1002, the system (e.g., the system 1200 in FIG. 9) receives an input prompt. In certain embodiments, the input prompt includes a plurality of requests to be fulfilled in parallel and/or in sequence. In some embodiments, at a layer in a model and/or by a machine-learning model, the input prompt is decomposed into a plurality of tokens.

In some embodiments, at process 1004, the system determines an expert workload distribution with respect to a plurality of experts in a mixture of experts (MoE) model for the input prompt (e.g., the plurality of tokens corresponding to the input prompt). In some embodiments, the determining an expert workload distribution includes determining the expert workload distribution with respect to the plurality of experts for the input prompt, by a gating network. In some embodiments, at process 1006, the system determines an expert placement layout with respect to a plurality of computing units for the input prompt based on the determined expert workload distribution.

In some embodiments, at process 1008, the system (e.g., the system 1200 in FIG. 9) compares the expert placement layout to a plurality of pre-determined expert placement layouts, each pre-determined expert placement layouts being associated with a respective cluster of computing devices. In some embodiments, at process 1010, the system selects a pre-determined expert placement layout from the plurality of pre-determined expert placement layouts based on the comparison.

In some embodiments, at process 1012, the system (e.g., the system 1200 in FIG. 9) routes the input prompt to a target cluster of computing devices corresponding to the selected pre-determined expert placement layout. In some embodiments, the system can route the input prompt to a selected target cluster having the highest similarity score (e.g., the target cluster 414 selected from the clusters 420-1, . . . , 420-N in FIG. 3). In some embodiments, when all dedicated computing devices in the target cluster are busy, the system can route the input prompt to one of the other clusters according to the similarity score rank (e.g., the second highest rank cluster of computing devices). In some embodiments, after having the routing result, the token dispatch result can be calculated given an expert placement playout using a token routing algorithm.

In some embodiments, the expert placement layout is an expert placement layout for a selected MoE layer (e.g., first MoE layer) of an MoE model. In some embodiments, the comparing the expert placement layout to a plurality of pre-determined expert placement layouts includes comparing the expert placement layout to respective expert placement layouts of the plurality of pre-determined expert placement layouts.

In some embodiments, the determining an expert placement layout with respect to the plurality of computing units based on the determined expert workload distribution further includes determining the expert placement layout to balance a first total workload of a first computing unit of the plurality of computing units and a second total workload of a second computing unit of the plurality of computing units.

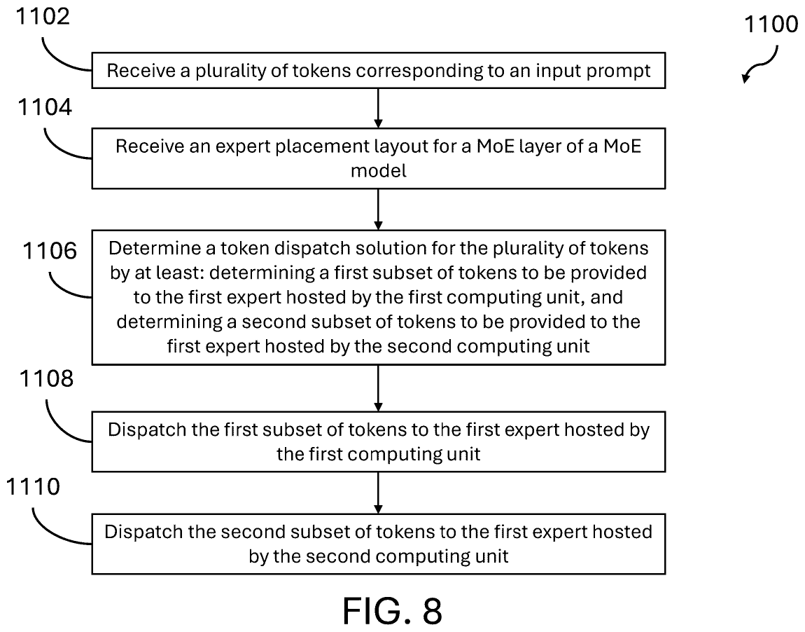

FIG. 8 is a flow diagram illustrating an exemplary method 1100 of dispatching tokens when running a mixture of experts (MoE) model, in accordance with embodiments of the subject matter of the disclosure. The method 1100 includes processes 1102, 1104, 1106, 1108, and 1110. Although the above has been shown using a selected group of processes for the method 1100, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

In some embodiments, some or all processes (e.g., steps) of the method 1100 are performed by a system (e.g., the computing system 1200 in FIG. 9). In certain examples, some or all processes (e.g., steps) of the method 1100 are performed by a computer and/or a processor directed by a code. In some examples, some or all processes (e.g., steps) of the method 900 are performed according to instructions included by a non-transitory computer-readable medium (e.g., in a computer program product, such as a computer-readable flash drive). For example, a non-transitory computer-readable medium is readable by a computer.

According to some embodiments, at process 1102, the system (e.g., the system 1200 in FIG. 9) receives a plurality of tokens corresponding to an input prompt. In certain embodiments, the input prompt includes a plurality of requests to be decomposed into a plurality of tokens (e.g., a plurality of initial tokens) to be input into expert models (e.g., an MoE model, etc.). In some examples, the plurality of tokens corresponding to the input prompt is for an MoE layer (e.g., MoE layer 11, etc.) that is generated from a previous MoE layer (e.g., MoE layer 10, etc.).

In some embodiments, at process 1104, the system (e.g., the system 1200 in FIG. 9) receives an expert placement layout for a MoE layer of the MoE model. In certain embodiments, the expert placement layout includes a plurality of sets of experts to be hosted by a plurality of computing units respectively, for example, a set of experts to be hosted by a respective computing unit. In some embodiments, the expert placement layout includes an indication of a first set of experts hosted by a first computing unit and an indication of a second set of experts hosted by a second computing unit. In some embodiments, the first set of experts includes a first expert, the second set of experts includes the first expert.

In some embodiments, at process 1106, the system (e.g., the system 1200 in FIG. 9) determines a token dispatch solution for a plurality of tokens corresponding to the input prompt. In some embodiments, the system receives an indication of a set of tokens to be provided to the first expert in the MoE layer. In some embodiments, the set of tokens is a part of the plurality of tokens corresponding to the input prompt. In some embodiments, the system determines the token dispatch solution by at least determining a first subset of tokens to be provided to the first expert hosted by the first computing unit based at least in part on a number of tokens to be input to other experts in the first set of experts, and determining a second subset of tokens to be provided to the first expert hosted by the second computing unit based at least in part on a number of tokens to be input to other experts in the second set of experts. In some embodiments, the first subset of tokens is a subset of the set of tokens to be provided to the first expert in the MoE layer, and the second subset of tokens is a subset of the set of tokens to be provided to the first expert in the MoE layer.

In some examples, as shown in FIG. 3, the system (e.g., the system 1200 in FIG. 9) determines a first subset of tokens hosted by a first computing unit (e.g., Expert “E1” allocated in GPU 421 for a MoE layer), and a second subset of tokens hosted by a second computing unit (e.g., a duplicate of Expert “E1” allocated in GPU 423 for the same MoE layer). Expert E1 and a duplicate of Expert E1 are allocated in GPUs 421 and 423 for a selected MoE layer (e.g., a first MoE layer), respectively. In some examples, the system can split the workload of 165 tokens for Expert “E1” into the first subset for GPU 621 and the second subset for GPU 623.

In some embodiments, at process 1108, the system (e.g., the system 1200 in FIG. 9) dispatches the first subset of tokens to the first expert hosted by the first computing unit. For example, in the above example, the system can dispatch the first subset (a portion of workload 165) of tokens to the first expert E1 hosted by GPU 0. In some embodiments, at process 1110, the system (e.g., the system 1200 in FIG. 9) dispatches the second number of tokens hosted by the second expert. For example, in the above example, the system (e.g., the system 1200 in FIG. 9) can dispatch the second subset (the rest of workload 165) of tokens to the first expert E1 hosted by GPU 1.

According to some embodiments, when the system dispatches the expert workload (e.g., tokens) of certain expert into a first computing unit and a second computing unit each hosting a duplicate of the expert, the first computing unit processes a first subset of tokens according to the token dispatch solution, and the second computing unit processes a second subset of tokens according to the token dispatch solution. In some embodiments, the first subset and the second subset of tokens can be determined based at least in part on the respective workload of the first computing unit and the second computing unit. For example, in some embodiments, the system can determine the number of tokens in the first subset to be more or less than that in the second subset in order to balance the total workload on different computing units (e.g., the first computing unit and the second computing unit).

In some embodiments, the system (e.g., the system 1200 in FIG. 9) further determines an expert placement layout with respect to the plurality of computing units, and determines a respective expert workload for the experts in a subset of the plurality of experts in the expert placement layout by determining the expert placement layout to balance a first total workload of a first computing unit of the plurality of computing units and a second total workload of a second computing unit of the plurality of computing units. In certain embodiments, the system (e.g., the system 1200 in FIG. 9) determines a token dispatch solution for an MoE layer of the MoE model.

In some embodiments, the token dispatch solution is determined based on at least one selected from a group consisting of a number of tokens to be provided to an expert hosted by a computing unit for an expert in the one MoE layer, a number of experts hosted by the computing unit, a maximum number of experts hosted by the computing unit, and an expert workload for the MoE layer, and/or the like. In certain embodiments, the token dispatch solution is determined using one or more functions including one or more variables including at least one selected from a group consisting of a number of tokens to be provided to an expert hosted by a computing unit for an expert in the one MoE layer, a number of experts hosted by the computing unit, a maximum number of experts hosted by the computing unit, and an expert workload for the MoE layer, and/or the like. In some embodiments, the token dispatch solution is determined using one or more functions including one or more variables including a number of tokens to be provided to an expert hosted by a computing unit for an expert in the one MoE layer, a number of experts hosted by the computing unit, a maximum number of experts hosted by the computing unit, and an expert workload for the MoE layer, and/or the like.

In certain examples, the system identifies a first subset of experts of a first set of experts hosted by a first computing unit, where each expert in the first subset of experts is only hosted by the first computing unit. In some examples, the system determines a first partial workload of the first computing unit, where the first partial workload is and/or includes an aggregated workload (e.g., a sum, etc.) of the first subset of experts. In certain examples, the system identifies a second subset of experts of a second set of experts hosted by a second computing unit, where each expert in the second subset of experts is only hosted by the second computing unit. In some examples, the system determines a second partial workload of the second computing unit, where the second partial workload is and/or includes an aggregated workload (e.g., a sum, etc.) of the second subset of experts. In certain examples, for a computing unit hosting an expert (e.g., a first expert) that has an expert duplicate (e.g., the first expert) hosted on another computing unit, the system determines a partial workload of the computing unit, where the partial workload is and/or includes an aggregated workload (e.g., a sum, etc.) of the one or more single-copy experts (e.g., no expert duplicate) hosted by the computing unit. In some embodiments, the system determines a split workload of the expert that has an expert duplicate, where the split workload is a part of the expert workload of the expert.

In certain embodiments, the system identifies one or more first duplicated experts in the first set of experts that are duplicated in one or more other computing units (e.g., a computing unit that is not the first computing unit, etc.), where the one or more first duplicated experts are not in the first subset of experts. In certain embodiments, the system identifies one or more second duplicated experts in the second set of experts that are duplicated in one or more other computing units (e.g., a computing unit that is not the second computing unit), where the one or more second duplicated experts are not in the second subset of experts. In some embodiments, the system identifies a first expert that is both one of the one or more first duplicated experts and one of the one or more second duplicated experts. In some embodiments, the system determines a first split workload of the first expert for the first computing unit based on the first partial workload and the second partial workload, where the first split workload is a part of the expert workload of the one of the one or more first duplicated experts.

In some embodiments, the system determines a first total workload of the first computing unit and a second total workload of the second computing unit based on the first partial workload and the second partial workload, such that a difference between the first total workload and the second total workload is less than a threshold, for example, a percentage (e.g., 50%, 25%, 20%, 10%, 5%, etc.) of the first total workload. In certain examples, the system performs the process described above for multiple pairs of computing units to achieve workload balancing.

According to certain embodiments, during the inference process, a prompt will first be routed to a dedicated computing device through the prompt router. In some embodiments, given the expert placement layout, a token dispatch solution (e.g., a token dispatch plan, an optimized token dispatch solution, an optimized token dispatch plan, etc.) for each layer can be calculated in real time. In some embodiments, for a single node (e.g., a computing device including multiple computing units such as, e.g., GPUs, TPUs, etc.), operation parameters can be defined as follows:
E ∈Z+: number of experts;
G ∈Z+: number of computing units (e.g., GPUs, TPUs, etc.);
L ∈Z+: number of MoE layers;
Wₑₗ ∈Z+: total workload of expert e in MoE layer I;
x_{egl} ∈{0, 1}: binary variable; 1 if expert e is placed on the computing unit g in MoE layer I;
y_{egl} ∈Z+: number of tokens handled by the computing unit g for expert e in layer I;
z_{gl} ∈Z+: workload of the computing unit g at MoE layer I;
zₘₐₓ, zₘᵢₙ ∈Z+: max and min expert workload at MoE layer I, constant after given the expert workload of prompt;
m ∈Z+: number of experts per MoE layer per computing unit.

In some embodiments, an objective of the exemplary algorithm (e.g., an objective function) can be user-defined. In an example, an objective function is to find y_{egl} to reduce or minimize (zₘₐₓ-zₘᵢₙ) for the MoE layer I with respect to at least some of the constraints below:

$${\sum }_{g = 1}^{G} {y}_{e g l} = {W}_{e l} , ∀ e ∈ \{ 1 , … , E \} , l ∈ \{ 1 , … , L \} \qquad ( B 1 )$$

$${y}_{e g l} \leq {W}_{e l} \cdot {x}_{e g l} , ∀ e ∈ \{ 1 , … , E \} , g ∈ \{ 1 , … , G \} , l ∈ \{ 1 , … , L \} \qquad ( B 2 )$$

$${y}_{e g l} \geq {x}_{e g l} , ∀ e ∈ \{ 1 , … , E \} , g ∈ \{ 1 , … , G \} , l ∈ \{ 1 , … , L \} \qquad ( B 3 )$$

$${z}_{g l} = {\sum }_{e = I}^{E} {y}_{e g l} ∀ g ∈ \{ 1 , … , G \} , l ∈ \{ 1 , … , L \} \qquad ( B 4 )$$

$${z}_{g l} \leq {z}_{l}^{max} ∀ g ∈ \{ 1 , … , G \} , l ∈ \{ 1 , … , L \} \qquad ( B 5 )$$

$${z}_{g l} \geq {z}_{l}^{min} ∀ g ∈ \{ 1 , … , G \} , l ∈ \{ 1 , … , L \} \qquad ( B 6 )$$

where (B4) indicates token assignments sum to total workload; (B2) indicates the token assignment only where expert is placed and the number is bounded by the total number of tokens routed to expert e in layer I; (B3) indicates every expert placement to carry at least one token (otherwise the weight does not have to be loaded); (B4) indicates that workload of GPU g at layer I equals the total expert workload on that GPU after the workload splits among the expert duplicates in that layer; and/or (B5) and (B6) introduce the min and max workload among all the GPUs at layer I and the solver searches for possible decision variables (e.g., y, or other decision variables that determine a solution for expert placement layouts) that satisfies all these inequalities such that the objective function can be minimized. In some examples, the inequalities can be certain constraints which are parts of a mathematical program other than the objective function. In certain examples, one or more of the constraints are user defined. In certain embodiments, the token dispatch solution is obtained based on the constraints and/or an objective function. In some embodiments, the system determines the token dispatch solution using the constraints and/or the objective function.

FIG. 9 is a simplified block diagram of a computing system 1200 (e.g., a server, a computing device, a computing system, etc.), with which aspects of the present disclosure may be practiced. The computing device components described below may be suitable for the computing devices described above. The computing system 1200 may a system 1204 which may include or couple to at least one processing unit. Depending on the configuration and type of computing device, the system 1204 may include, for example, volatile storage (e.g., random access memory), non-volatile storage (e.g., read-only memory), flash memory, or any combination of such memories.

The system 1204 may include an operating system 1205 suitable for running a software application, such as one or more components supported by the systems described herein. As examples, system 1204 may store a clustering engine or processor 1222, a prompt router engine 1224, an inference engine or processor 1226, and/or other engines described herein. The operating system 1205, for example, may be suitable for controlling the operation of the computing system 1200.

According to certain embodiments, the clustering engine and/or processor 1222 can implement various methods (e.g., the method 900, etc.), MoE models, and/or components of a MoE model for clustering expert workload distributions and/or expert placement layouts. In some embodiments, the clustering engine and/or processor 1222 can be associated with one or more parts 200A, 200B, and 200C of the system 200 in FIGS. 1-3.

According to certain embodiments, the prompt router engine and/or processor 1224 can implement various methods (e.g., the method 1000, etc.), MoE models, and/or components of a MoE model for determine an expert workload distribution and an expert placement layout for an incoming prompt. In some embodiments, the prompt router engine and/or processor 1224 can be associated with one or more parts 200A, 200B, and 200C of the system 200 in FIGS. 1-3.

According to certain embodiments, the inference engine and/or processor 1226 can implement various methods (e.g., the method 1100, etc.), MoE models, or components of a MoE model for providing an expert placement layout for an input prompt and/or token dispatches for a mixture of experts (MoE) model. In some embodiments, the interference engine and/or processor 1226 can be associated with one or more parts 200A, 200B, and 200C of the system 200 in FIGS. 1-3.

A basic configuration is illustrated in FIG. 9 by those components within a dashed line 1208. The computing system 1200 may have additional features or functionality. For example, the computing system 1200 may also include additional data storage devices (removable and/or non-removable) such as, for example, magnetic disks, optical disks, or tape. Such additional storage is illustrated in FIG. 9 by a removable storage device 1209 and a non-removable storage device 1210.

As stated above, a number of programs and data files may be stored in the system 1204. While executing on a processing unit, the engines 1222, 1224 and 1226 may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, and the like.

Furthermore, aspects of the disclosure may be practiced in an electrical circuit including discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1000 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general-purpose computer or in any other circuits or systems.

The computing system 1200 may also have one or more input device(s) 1212 such as a keyboard, a mouse, a pen, a sound or voice input device, a touch or swipe input device, and the like. The output device(s) 1214 such as a display, speakers, a printer, etc. may also be included. The aforementioned devices are examples and others may be used. The computing system 1200 may include one or more communication connections 1216 allowing communications with computing units 1250 (e.g., GPUs, TPUs, etc.). Examples of suitable communication connections 1216 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system 1204, the removable storage device 1209, and the non-removable storage device 1210 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing system 1200. Any such computer storage media may be part of the computing system 1200. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

According to certain embodiments, a method for determining expert placement layouts for a mixture of experts (MoE) model is provided. The method includes receiving a plurality of tokens corresponding to an input prompt; receiving, by one or more processors, routing information of the plurality of tokens corresponding to at least a subset of a plurality of experts in one MoE layer of a plurality of MoE layers in the MoE model, the routing information including a subset of tokens per expert in the subset of the plurality of experts; determining, by the one or more processors, a respective expert workload for each expert in the at least the subset of the plurality of experts based on the routing information; determining, by the one or more processors, an expert workload distribution with respect to the plurality of experts based on the respective expert workload for each expert in the at least the subset of the plurality of experts; and determining, by the one or more processors, an expert placement layout with respect to a plurality of computing units based on the determined expert workload distribution for the one MoE layer of the plurality of MoE layers.

In some embodiments, the method further includes comparing the expert placement layout to a plurality of pre-determined expert placement layouts, each pre-determined expert placement layouts being associated with a respective cluster of computing devices in the plurality of computing device clusters; selecting a pre-determined expert placement layout from the plurality of pre-determined expert placement layouts based on the comparison; and routing the input prompt to a target cluster of computing devices corresponding to the selected pre-determined expert placement layout, the target cluster being one of the plurality of computing device clusters.

In some embodiments, the determining an expert placement layout with respect to the plurality of computing units based on the determined expert workload distribution further includes determining the expert placement layout for the one MoE layer of the MoE model based on at least one selected from a group consisting of a number of tokens to be provided to an expert hosted by a computing unit for an expert in the one MoE layer, a number of experts hosted by the computing unit, a maximum number of experts hosted by the computing unit, and an expert workload for the MoE layer.

In some embodiments, the method further includes receiving a plurality of input prompts; determining a respective expert workload distribution with respect to a plurality of experts for each input prompt of the plurality of input prompts; determining, for a selected layer of a plurality of layers in the MoE model, a respective expert placement layout with respect to a plurality of computing units for each input prompt of the plurality of input prompts based on the respective expert workload distribution; and determining a similarity between two or more expert placement layouts of the plurality of expert placement layouts; and clustering the plurality of expert placement layouts into a plurality of layout clusters based on the determined similarity.

In some embodiments, the method further includes determining a plurality of expert workload distribution clusters based at least in part on the plurality of layout clusters; clustering the plurality of input prompts into a plurality of prompt clusters based on a plurality of expert workload distribution clusters.

In some embodiments, the method further includes sampling a representative expert workload distribution from the respective expert workload distributions within each distribution cluster of the plurality of expert workload distribution clusters; determining an expert placement layout for a layout cluster of the plurality of layout clusters based on the representative expert workload distribution.

In some embodiments, the method further includes loading a plurality of determined expert placement layouts onto a plurality of computing devices in a plurality of computing device clusters corresponding to the plurality of layout clusters; wherein the plurality of expert placement layouts are different from each other; wherein an expert placement layout of the plurality of expert placement layouts is loaded on one or more computing devices of a respective computing device cluster of the plurality of computing device clusters; wherein the one or more computing devices include at least a part of the plurality of computing units.

In some embodiments, a first computing device in a first computing device cluster of the plurality of computing device clusters is loaded with a first expert placement layout; wherein a second computing device in a second computing device cluster of the plurality of computing device clusters is loaded with a second expert placement layout; wherein the first expert placement layout is different from the second expert placement layout; wherein the first computing device cluster does not include any computing device in the second computing device cluster.

In some embodiments, the method further includes receiving one or more new input prompts; determining one or more updated expert placement layouts for the one or more new input prompts; updating the determined expert placement layout based at least in part on the one or more updated expert placement layouts.

In some embodiments, the one MoE layer is a first MoE layer, wherein the determining an expert placement layout comprises determining the expert placement layout with respect to a plurality of computing units based on the determined expert workload distribution for the first MoE layer of the plurality of MoE layers.

In some embodiments, a first computing unit of the plurality of computing units hosts a first set of experts having a first total workload according to the expert placement layout, wherein a second computing unit of the plurality of computing units hosts a second set of experts having a second total workload, wherein a difference between the first total workload and the second total workload is less than ten percent of the first total workload.

In some embodiments, the method further includes determining a plurality of expert workloads for the plurality of tokens corresponding to the input prompt with respect to at least the subset of the plurality of experts hosted by a plurality of computing units, a first total workload of the plurality of expert workloads including a first subset of tokens to be provided to a first expert of the plurality of experts hosted by a first computing unit of the plurality of computing units, a second total workload of the plurality of expert workloads including a second subset of tokens to be provided to the first expert of the plurality of experts hosted by a second computing unit of the plurality of computing units; and dispatching the first subset of tokens to the first expert hosted by the first computing unit; and dispatching the second subset of tokens to the first expert hosted by the second computing unit.

In some embodiments, at least one expert of the plurality of experts is allocated in a first computing unit of the plurality of computing units and a duplicate of the at least one expert is allocated in a second computing unit of the plurality of computing units. In some embodiments, the method further includes splitting the expert workload of the at least one expert into the first computing unit and the second computing unit. In some embodiments, the expert placement layout includes a number of tokens to be provided to and/or handled by each expert of one or more experts that is hosted by a computing unit of the plurality of computing units.

In some embodiments, the respective expert workload for a respective expert of the plurality of experts includes the number of tokens associated with the respective expert. In some embodiments, the one MoE layer is a first MoE layer, wherein the determining an expert placement layout includes determining the expert placement layout with respect to a plurality of computing units based on the determined expert workload distribution for the first MoE layer of the plurality of MoE layers. In some embodiments, a first computing unit of the plurality of computing units hosts a first set of experts having a first total workload according to the expert placement layout, wherein a second computing unit of the plurality of computing units hosts a second set of experts having a second total workload, wherein a difference between the first total workload and the second total workload is less than ten percent of the first total workload.

In some embodiments, the method further includes determining a plurality of expert workloads for the plurality of tokens corresponding to the input prompt with respect to at least the subset of the plurality of experts hosted by a plurality of computing units, a first total workload of the plurality of expert workloads including a first subset of tokens to be provided to a first expert of the plurality of experts hosted by a first computing unit of the plurality of computing units, a second total workload of the plurality of expert workloads including a second subset of tokens to be provided to a first expert of the plurality of experts hosted by a second computing unit of the plurality of computing units. The method includes dispatching the first subset of tokens to the first expert hosted by the first computing unit, dispatching the second subset of tokens to the first expert hosted by the second computing unit.

According to certain embodiments, a system for determining expert placement layouts for a mixture of experts (MoE) model is provided. The system includes at least one processor; and memory storing instructions that, when executed by the at least one processor, cause the system to perform a set of operations. The set of operations includes receiving a plurality of tokens corresponding to an input prompt; receiving routing information of the plurality of tokens corresponding to at least a subset of a plurality of experts in one MoE layer of a plurality of MoE layers in the MoE model, the routing information including a subset of tokens per expert in the subset of the plurality of experts; determining a respective expert workload for each expert in the at least the subset of the plurality of experts based on the routing information; determining an expert workload distribution with respect to the plurality of experts based on the respective expert workload for each expert in the at least the subset of the plurality of experts; and determining an expert placement layout with respect to a plurality of computing units based on the determined expert workload distribution for the plurality of MoE layers.

In some embodiments, the set of operations includes comparing the expert placement layout to a plurality of pre-determined expert placement layouts, each pre-determined expert placement layouts being associated with a respective cluster of computing devices in the plurality of computing device clusters; selecting a pre-determined expert placement layout from the plurality of pre-determined expert placement layouts based on the comparison; and routing the input prompt to a target cluster of computing devices corresponding to the selected pre-determined expert placement layout, the target cluster being one of the plurality of computing device clusters.

In some embodiments, the set of operations includes determining the expert placement layout for the one MoE layer of the MoE model based on at least one selected from a group consisting of a number of tokens to be provided to an expert hosted on a computing unit for the expert in the one MoE layer, a number of experts hosted by the computing unit, a maximum number of experts hosted by the computing unit, and an expert workload for the computing unit for the one MoE layer. In some embodiments, at least one expert of the plurality of experts is allocated in a first computing unit of the plurality of computing units and a duplicate of the at least one expert is allocated in a second computing unit of the plurality of computing units.

In some embodiments, the set of operations includes splitting the expert workload of the at least one expert into the first computing unit and the second computing unit. In some embodiments, each expert of the plurality of experts includes one or more feedforward neural networks (FFNs).

In some embodiments, the expert placement layout includes a number of tokens to be provided to and/or handled by one expert of one or more experts that is hosted by a computing unit of the plurality of computing units. In some embodiments, the respective expert workload for a respective expert of the plurality of experts includes the number of tokens associated with the respective expert. In some embodiments, the one MoE layer is a first MoE layer, wherein the determining an expert placement layout includes using the expert placement layout for the first MoE layer of the plurality of MoE layers.

In some embodiments, the set of operations comprise receiving a plurality of input prompts; determining a respective expert workload distribution with respect to a plurality of experts for each input prompt of the plurality of input prompts; determining, for a selected layer of a plurality of layers in the MoE model, a respective expert placement layout with respect to a plurality of computing units for each input prompt of the plurality of input prompts based on the respective expert workload distribution; and determining a similarity between two or more expert placement layouts of the plurality of expert placement layouts; and clustering the plurality of expert placement layouts into a plurality of layout clusters based on the determined similarity.

In some embodiments, the set of operations comprise determining a plurality of expert workload distribution clusters based at least in part on the plurality of layout clusters; clustering the plurality of input prompts into a plurality of prompt clusters based on a plurality of expert workload distribution clusters. In some embodiments, the set of operations comprise sampling a representative expert workload distribution from the respective expert workload distributions within each distribution cluster of the plurality of expert workload distribution clusters; determining an expert placement layout for a layout cluster of the plurality of layout clusters based on the representative expert workload distribution.

In some embodiments, the set of operations comprise loading a plurality of determined expert placement layouts onto a plurality of computing devices in a plurality of computing device clusters corresponding to the plurality of layout clusters; wherein the plurality of expert placement layouts are different from each other; wherein an expert placement layout of the plurality of expert placement layouts is loaded on one or more computing devices of a respective computing device cluster of the plurality of computing device clusters; wherein the one or more computing devices include at least a part of the plurality of computing units. In some embodiments, the set of operations comprise receiving one or more new input prompts; determining one or more updated expert placement layouts for the one or more new input prompts; updating the determined expert placement layout based at least in part on the one or more updated expert placement layouts.

In some embodiments, the one MoE layer is a first MoE layer, wherein the determining an expert placement layout comprises determining the expert placement layout with respect to a plurality of computing units based on the determined expert workload distribution for the first MoE layer of the plurality of MoE layers.

In some embodiments, a first computing unit of the plurality of computing units hosts a first set of experts having a first total workload according to the expert placement layout, wherein a second computing unit of the plurality of computing units hosts a second set of experts having a second total workload, wherein a difference between the first total workload and the second total workload is less than ten percent of the first total workload.

In some embodiments, the set of operations comprise determining a plurality of expert workloads for the plurality of tokens corresponding to the input prompt with respect to at least the subset of the plurality of experts hosted by a plurality of computing units, a first total workload of the plurality of expert workloads including a first subset of tokens to be provided to a first expert of the plurality of experts hosted by a first computing unit of the plurality of computing units, a second total workload of the plurality of expert workloads including a second subset of tokens to be provided to the first expert of the plurality of experts hosted by a second computing unit of the plurality of computing units; and dispatching the first subset of tokens to the first expert hosted by the first computing unit; and dispatching the second subset of tokens to the first expert hosted by the second computing unit.

According to certain embodiments, a non-transitory computer-readable medium storing instructions for determining expert placement layouts for a mixture of experts (MoE) model, the instructions when executed by one or more processors of a computing device, cause the one or more processors to perform a set of operations comprising receiving a plurality of tokens corresponding to an input prompt; receiving routing information of the plurality of tokens corresponding to at least a subset of a plurality of experts in one MoE layer of a plurality of MoE layers in the MoE model, the routing information including a subset of tokens per expert in the subset of the plurality of experts; determining a respective expert workload for each expert in the at least the subset of the plurality of experts based on the routing information; determining an expert workload distribution with respect to the plurality of experts based on the respective expert workload for each expert in the at least the subset of the plurality of experts; and determining an expert placement layout with respect to a plurality of computing units based on the determined expert workload distribution for the one MoE layer of the plurality of MoE layers.

According to certain embodiments, a method of clustering in determining expert placement layouts for a mixture of experts (MoE) model is provided. The method includes receiving a plurality of input prompts; determining a respective expert workload distribution with respect to a plurality of experts for each input prompt of the plurality of input prompts; determining, for a selected layer of a plurality of layers in the MoE model, a respective expert placement layout with respect to a plurality of computing units for each input prompt of the plurality of input prompts based on the respective expert workload distribution; and for every two expert placement layouts of the plurality of expert placement layouts corresponding to at least a part of the plurality of experts, determining a similarity between the every two expert placement layouts of a plurality of expert placement layouts; and clustering the plurality of expert placement layouts into a plurality of layout clusters based on the determined similarity.

In some embodiments, the selected layer is a first MoE layer in the MoE model. In some embodiments, the method further includes clustering the respective expert workload distributions into a plurality of expert workload distribution clusters based on the plurality of layout clusters.

In some embodiments, the method further includes clustering the input prompts into a plurality of prompt clusters based on the plurality of expert workload distribution clusters. In some embodiments, the method further includes determining a plurality of expert workload distribution clusters based at least in part on the plurality of layout clusters. In some embodiments, the method further includes sampling a representative expert workload distribution from the respective expert workload distributions within each expert workload distribution cluster of the plurality of expert workload distribution clusters.

In some embodiments, the method further includes determining an expert placement layout for a layout cluster of the plurality of layout clusters based on the representative expert workload distribution for each expert workload distribution cluster of the plurality of expert workload distribution clusters. In some embodiments, the determined expert placement layout includes a plurality of expert placement layouts for a plurality of MoE layers of the MoE model.

In some embodiments, the method further includes loading a plurality of determined expert placement layouts onto a plurality of computing devices in a plurality of computing device clusters corresponding to the plurality of layout clusters, wherein the plurality of expert placement layouts are different from each other, wherein an expert placement layout of the plurality of expert placement layouts is loaded on one or more computing devices of a respective computing device cluster of the plurality of computing device clusters; wherein the one or more computing devices include at least a part of the plurality of computing units.

In some embodiments, a first computing device in a first computing device cluster of the plurality of computing device clusters is loaded with a first expert placement layout, wherein a second computing device in a second computing device cluster of the plurality of computing device clusters is loaded with a second expert placement layout, wherein the first expert placement layout is different from the second expert placement layout, wherein the first computing device cluster does not include any computing device in the second computing device cluster.

In some embodiments, the method further includes receiving one or more new input prompts; determining one or more updated expert placement layouts for the one or more new input prompts; updating the determined expert placement layout based at least in part on the one or more updated expert placement layouts.

According to certain embodiments, a method of routing for input prompts is provided. The method includes receiving the input prompt; determining an expert workload distribution with respect to a plurality of experts in a mixture of experts (MoE) model for the input prompt; determining an expert placement layout with respect to a plurality of computing units for the input prompt based on the determined expert workload distribution; comparing the expert placement layout to a plurality of pre-determined expert placement layouts, each pre-determined expert placement layouts being associated with a respective cluster of computing device in a plurality of computing device clusters; selecting a pre-determined expert placement layout from the plurality of pre-determined expert placement layouts based on the comparison; and routing the input prompt to a target cluster of computing devices corresponding to the selected pre-determined expert placement layout. The target cluster is one of the plurality of computing device clusters.

In some embodiments, the determining an expert workload distribution includes determining the expert workload distribution with respect to the plurality of experts for the input prompt, by a gating processor. In some embodiments, the expert placement layout is an expert placement layout for a selected MoE layer of an MoE model; and the comparing the expert placement layout to a plurality of pre-determined expert placement layouts includes comparing the expert placement layout to respective layer expert placement layouts of the plurality of pre-determined expert placement layouts.

In some embodiments, the comparing the expert placement layout to a plurality of pre-determined expert placement layouts comprises comparing the expert placement layout of the selected MoE layer to the plurality of pre-determined expert placement layouts each at a representative layer. In some embodiments, the method further includes determining a layer expert workload for the plurality of experts for one MoE layer of the MoE model.

In some embodiments, the method further includes, for a MoE layer in the MoE model, determining a first total workload for a first set of experts hosted by a first computing unit of a plurality of computing units of the respective cluster of computing devices; and determining a second total workload for a second set of experts hosted by a second computing unit of the plurality of computing units; wherein a difference between the first total workload and the second total workload is within a threshold.

According to certain embodiments, a method of dispatching tokens when running a mixture of experts (MoE) model is provided. The method includes receiving a plurality of tokens corresponding to an input prompt; receiving an expert placement layout for a MoE layer of the MoE model, the expert placement layout including an indication of a first set of experts hosted by a first computing unit and an indication of a second set of experts hosted by a second computing unit, the first set of experts including a first expert, the second set of experts including the first expert; determining a token dispatch solution for the plurality of tokens by at least: receiving an indication of a set of tokens to be provided to the first expert in the MoE layer, the set of tokens being a part of the plurality of tokens; determining a first subset of tokens to be provided to the first expert hosted by the first computing unit based at least in part on a number of tokens to be input to other experts in the first set of experts, the first subset of tokens being a subset of the set of tokens; and determining a second subset of tokens to be provided to the first expert hosted by the second computing unit based at least in part on a number of tokens to be input to other experts in the second set of experts, the second subset of tokens being a subset of the set of tokens; dispatching the first subset of tokens to the first expert hosted by the first computing unit; and dispatching the second subset of tokens to the first expert hosted by the second computing unit.

In some embodiments, the determining a token dispatch solution includes determining a first number of tokens in the first subset of tokens, and a second number of tokens in the second subset of tokens. In some embodiments, the determining a token dispatch solution includes determining a first number of tokens in the first subset of tokens; determining a second number of tokens in the second subset of tokens; determining a first total workload for the first computing unit based on the first number of tokens and a number of tokens to be input to other experts in the first set of experts; and determining a second total workload for the second computing unit based on the second number of tokens and a number of tokens to be input to other experts in the second set of experts. In some embodiments, a difference between the first total workload and the second total workload is less than ten percent of the first total workload.

In some embodiments, the set of tokens to input to the first expert splits into the first subset and the second subset. In some embodiments, the determining a token dispatch solution includes determining the token dispatch solution for an MoE layer of the MoE model based on at least one selected from a group consisting of a number of tokens handled by a computing unit for an expert in the MoE layer, a number of experts allocated for the MoE layer, a selected expert placement, and a number indicative an expert workload for the MoE layer. In some embodiments, the determining a token dispatch solution includes determining a token dispatch solution of a set of selected experts for each MoE layer of the MoE model.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as they fall within the scope of the claims, together with all equivalents thereof.

We claim:

1. A method for determining expert placement layouts for a mixture of experts (MoE) model, the method comprising:
receiving a plurality of tokens corresponding to an input prompt;
receiving, by one or more processors, routing information of the plurality of tokens corresponding to at least a subset of a plurality of experts in one MoE layer of a plurality of MoE layers in the MoE model, the routing information including a subset of tokens per expert in the subset of the plurality of experts;
determining, by the one or more processors, a respective expert workload for each expert in the at least the subset of the plurality of experts based on the routing information;
determining, by the one or more processors, an expert workload distribution with respect to the plurality of experts based on the respective expert workload for each expert in the at least the subset of the plurality of experts; and
determining, by the one or more processors, an expert placement layout with respect to a plurality of computing units based on the determined expert workload distribution for the one MoE layer of the plurality of MoE layers.

2. The method of claim 1, further comprising:
comparing the expert placement layout to a plurality of pre-determined expert placement layouts, each pre-determined expert placement layouts being associated with a respective cluster of computing devices in a plurality of computing device clusters;
selecting a pre-determined expert placement layout from the plurality of pre-determined expert placement layouts based on the comparison; and
routing the input prompt to a target cluster of computing devices corresponding to the selected pre-determined expert placement layout, the target cluster being one of the plurality of computing device clusters.

3. The method of claim 1, wherein determining an expert placement layout with respect to the plurality of computing units based on the determined expert workload distribution further comprises:
determining the expert placement layout for the one MoE layer of the MoE model based on at least one selected from a group consisting of a number of tokens to be provided to an expert hosted on a computing unit for the expert in the one MoE layer, a number of experts hosted by the computing unit, a maximum number of experts hosted by the computing unit, and an expert workload for the computing unit for the one MoE layer.

4. The method of claim 1, further comprising:
receiving a plurality of input prompts;
determining a respective expert workload distribution with respect to a plurality of experts for each input prompt of the plurality of input prompts;
determining, for a selected layer of a plurality of layers in the MoE model, a respective expert placement layout with respect to a plurality of computing units for each input prompt of the plurality of input prompts based on the respective expert workload distribution; and
determining a similarity between two or more expert placement layouts of the plurality of expert placement layouts; and
clustering the plurality of expert placement layouts into a plurality of layout clusters based on the determined similarity.

5. The method of claim 4, further comprising:
determining a plurality of expert workload distribution clusters based at least in part on the plurality of layout clusters;
clustering the plurality of input prompts into a plurality of prompt clusters based on a plurality of expert workload distribution clusters.

6. The method of claim 5, further comprising sampling a representative expert workload distribution from the respective expert workload distributions within each distribution cluster of the plurality of expert workload distribution clusters;
determining an expert placement layout for a layout cluster of the plurality of layout clusters based on the representative expert workload distribution.

7. The method of claim 6, further comprising:
loading a plurality of determined expert placement layouts onto a plurality of computing devices in a plurality of computing device clusters corresponding to the plurality of layout clusters;
wherein the plurality of expert placement layouts are different from each other;
wherein an expert placement layout of the plurality of expert placement layouts is loaded on one or more computing devices of a respective computing device cluster of the plurality of computing device clusters;
wherein the one or more computing devices include at least a part of the plurality of computing units.

8. The method of claim 4, further comprising:
receiving one or more new input prompts;
determining one or more updated expert placement layouts for the one or more new input prompts;
updating the determined expert placement layout based at least in part on the one or more updated expert placement layouts.

9. The method of claim 1, wherein the one MoE layer is a first MoE layer, wherein the determining an expert placement layout comprises determining the expert placement layout with respect to a plurality of computing units based on the determined expert workload distribution for the first MoE layer of the plurality of MoE layers.

10. The method of claim 1, wherein a first computing unit of the plurality of computing units hosts a first set of experts having a first total workload according to the expert placement layout, wherein a second computing unit of the plurality of computing units hosts a second set of experts having a second total workload, wherein a difference between the first total workload and the second total workload is less than ten percent of the first total workload.

11. The method of claim 1, further comprising:
determining a plurality of expert workloads for the plurality of tokens corresponding to the input prompt with respect to at least the subset of the plurality of experts hosted by a plurality of computing units, a first total workload of the plurality of expert workloads including a first subset of tokens to be provided to a first expert of the plurality of experts hosted by a first computing unit of the plurality of computing units, a second total workload of the plurality of expert workloads including a second subset of tokens to be provided to the first expert of the plurality of experts hosted by a second computing unit of the plurality of computing units; and
dispatching the first subset of tokens to the first expert hosted by the first computing unit; and
dispatching the second subset of tokens to the first expert hosted by the second computing unit.

12. A system for determining expert placement layouts for a mixture of experts (MoE) model, the system comprising:
at least one processor; and
memory storing instructions that, when executed by the at least one processor, cause the system to perform a set of operations, the set of operations comprising:
receiving a plurality of tokens corresponding to an input prompt;
receiving routing information of the plurality of tokens corresponding to at least a subset of a plurality of experts in one MoE layer of a plurality of MoE layers in the MoE model, the routing information including a subset of tokens per expert in the subset of the plurality of experts;
determining a respective expert workload for each expert in the at least the subset of the plurality of experts based on the routing information;
determining an expert workload distribution with respect to the plurality of experts based on the respective expert workload for each expert in the at least the subset of the plurality of experts; and
determining an expert placement layout with respect to a plurality of computing units based on the determined expert workload distribution for the plurality of MoE layers.

13. The system of claim 12, wherein the set of operations comprise:
comparing the expert placement layout to a plurality of pre-determined expert placement layouts, each pre-determined expert placement layouts being associated with a respective cluster of computing devices in a plurality of computing device clusters;
selecting a pre-determined expert placement layout from the plurality of pre-determined expert placement layouts based on the comparison; and
routing the input prompt to a target cluster of computing devices corresponding to the selected pre-determined expert placement layout, the target cluster being one of the plurality of computing device clusters.

14. The system of claim 12, wherein the set of operations comprise:
determining the expert placement layout for the one MoE layer of the MoE model based on at least one selected from a group consisting of a number of tokens to be provided to an expert hosted on a computing unit for the expert in the one MoE layer, a number of experts hosted by the computing unit, a maximum number of experts hosted by the computing unit, and an expert workload for the computing unit for the one MoE layer.

15. The system of claim 12, wherein the set of operations comprise:
receiving a plurality of input prompts;
determining a respective expert workload distribution with respect to a plurality of experts for each input prompt of the plurality of input prompts;
determining, for a selected layer of a plurality of layers in the MoE model, a respective expert placement layout with respect to a plurality of computing units for each input prompt of the plurality of input prompts based on the respective expert workload distribution; and
determining a similarity between two or more expert placement layouts of the plurality of expert placement layouts; and
clustering the plurality of expert placement layouts into a plurality of layout clusters based on the determined similarity.

16. The system of claim 15, wherein the set of operations comprise:
determining a plurality of expert workload distribution clusters based at least in part on the plurality of layout clusters;
clustering the plurality of input prompts into a plurality of prompt clusters based on a plurality of expert workload distribution clusters.

17. The system of claim 16, wherein the set of operations comprise:
sampling a representative expert workload distribution from the respective expert workload distributions within each distribution cluster of the plurality of expert workload distribution clusters;
determining an expert placement layout for a layout cluster of the plurality of layout clusters based on the representative expert workload distribution.

18. The system of claim 12, wherein the one MoE layer is a first MoE layer, wherein the determining an expert placement layout comprises determining the expert placement layout with respect to a plurality of computing units based on the determined expert workload distribution for the first MoE layer of the plurality of MoE layers.

19. The system of claim 12, wherein a first computing unit of the plurality of computing units hosts a first set of experts having a first total workload according to the expert placement layout, wherein a second computing unit of the plurality of computing units hosts a second set of experts having a second total workload, wherein a difference between the first total workload and the second total workload is less than ten percent of the first total workload.

20. A non-transitory computer-readable medium storing instructions for determining expert placement layouts for a mixture of experts (MoE) model, the instructions when executed by one or more processors, cause the one or more processors to perform a set of operations comprising:
receiving a plurality of tokens corresponding to an input prompt;
receiving routing information of the plurality of tokens corresponding to at least a subset of a plurality of experts in one MoE layer of a plurality of MoE layers in the MoE model, the routing information including a subset of tokens per expert in the subset of the plurality of experts;
determining a respective expert workload for each expert in the at least the subset of the plurality of experts based on the routing information;
determining an expert workload distribution with respect to the plurality of experts based on the respective expert workload for each expert in the at least the subset of the plurality of experts; and
determining an expert placement layout with respect to a plurality of computing units based on the determined expert workload distribution for the plurality of MoE layers.
